(19) United States
(12) Patent Application Publication
(10) Pub. No.: US 2022/0173429 A1
(43) Pub. Date: Jun. 2, 2022

(54) STORAGE BATTERY AND VEHICLE INCLUDING STORAGE BATTERY

(71) Applicant: SEMICONDUCTOR ENERGY LABORATORY CO., LTD., Atsugi-shi (JP)

(72) Inventors: Masayuki KIMURA, Atsugi (JP); Kaori OGITA, Isehara (JP); Fumiko TANAKA, Atsugi (JP); Shotaro MURATSUBAKI, Atsugi (JP)

(21) Appl. No.: 17/530,763

(22) Filed: Nov. 19, 2021

(30) Foreign Application Priority Data
Nov. 27, 2020 (JP) 2020-197235

(51) Int. Cl. H01M 10/0525; H01M 4/525; H01M 10/0569; H01M 10/0568

(52) U.S. Cl. CPC H01M 10/0525; H01M 10/0568; H01M 10/0569; H01M 4/525

(57) ABSTRACT

A storage battery that is less likely to be affected by the ambient temperature is provided. A storage battery that can be charged and discharged at low temperatures is provided. In the storage battery, a secondary battery that can be charged and discharged at low temperatures is provided adjacent to a general secondary battery. The storage battery having such a structure can use, as an internal heat source in a low temperature environment, heat generated by charging and discharging of the secondary battery that can be charged and discharged at low temperatures. Specifically, the storage battery includes a first lithium-ion secondary battery and a second lithium-ion secondary battery adjacent to each other. The first lithium-ion secondary battery contains at least one of an ionic liquid, a molecular crystalline electrolyte, a semi-solid-state electrolyte, an all-solid-state electrolyte, and lithium titanate. The second lithium-ion secondary battery contains an organic electrolyte solution.

### BACKGROUND OF THE INVENTION

### 1. Field of the Invention

The present invention relates to a storage battery and a method for manufacturing the storage battery. Alternatively, the present invention relates to a vehicle or the like including a storage battery.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that a power storage device in this specification refers to every element and device having a function of storing electric power. For example, a power storage device (also referred to as a secondary battery) such as a lithium-ion secondary battery, a lithium-ion capacitor, and an electric double layer capacitor are included in the category of the power storage device.

### 2. Description of the Related Art

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers; portable music players; digital cameras; medical equipment; next-generation clean energy vehicles such as hybrid vehicles (HVs), electric vehicles (EVs), and plug-in hybrid vehicles (PHVs); and the like. The lithium-ion secondary batteries are essential as rechargeable energy supply sources for today's information society.

General lithium-ion secondary batteries have a problem in charging and discharging at low temperatures or high temperatures. At low temperatures especially below freezing, the viscosity of an organic solvent contained in a secondary battery increases, which makes it difficult to obtain good charge and discharge characteristics. However, a secondary battery is desired to operate stably regardless of the surrounding environment, and thus a heater has been provided around the secondary battery as a countermeasure (see Patent Document 1, for example).

### REFERENCE

### Patent Document

[Patent Document 1] Japanese Published Application No. H08-138762

### Non-Patent Document

[Non-Patent Document 1] Shannon et al., Acta A 32 (1976) 751.

### SUMMARY OF THE INVENTION

Providing an external heat source such as a heater increases the cost and the risk of malfunction. In view of this, an object of one embodiment of the present invention is to provide a storage battery that operates stably regardless of the surrounding environment by controlling the temperature of a secondary battery without an external heat source such as a heater. Another object is to provide a highly safe storage battery.

Another object of one embodiment of the present invention is to provide a method for manufacturing the storage battery.

Note that the descriptions of these objects do not preclude the existence of other objects. In one embodiment of the present invention, there is no need to achieve all these objects. Other objects can be derived from the descriptions of the specification, the drawings, and the claims.

To solve the above problems, in the storage battery of one embodiment of the present invention, a secondary battery that can be charged and discharged at low temperatures is provided adjacent to a general secondary battery. The storage battery having such a structure can use, as an internal heat source in a low temperature environment, heat generated by charging and discharging of the secondary battery that can be charged and discharged at low temperatures.

One embodiment of the present invention is a storage battery including a first lithium-ion secondary battery and a second lithium-ion secondary battery adjacent to each other. The first lithium-ion secondary battery contains at least one of an ionic liquid, a molecular crystalline electrolyte, a semi-solid-state electrolyte, an all-solid-state electrolyte, and lithium titanate. The second lithium-ion secondary battery contains an organic electrolyte solution.

In the above, the storage battery can further include a temperature sensor and a control circuit. An operating temperature range of the first lithium-ion secondary battery can be a first temperature range, and an operating temperature range of the second lithium-ion secondary battery can be a second temperature range including an upper limit of the first temperature range. A lower limit of the first temperature range can be lower than a lower limit of the second temperature range. The temperature sensor can have a function of sensing a temperature of the second lithium-ion secondary battery. The control circuit can have a function of making the first lithium-ion secondary battery generate heat so that the second lithium-ion secondary battery is heated to the second temperature range, when the temperature sensed by the temperature sensor is lower than the second temperature range.

In the above, it is preferable that the first lithium-ion secondary battery have a function of an auxiliary heat source and the second lithium-ion secondary battery have a function of starting to perform discharging to the outside after the temperature reaches the second temperature range.

In the above, the number of the first lithium-ion secondary batteries is preferably smaller than the number of the second lithium-ion secondary batteries.

In the above, it is preferable that the first lithium-ion secondary battery and the second lithium-ion secondary battery be substantially rectangular solids and placed such that their largest surfaces face each other.

In the above, a material having higher thermal conductivity than air is preferably contained between the first lithium-ion secondary battery and the second lithium-ion secondary battery.

In the above, it is preferable that the first lithium-ion secondary battery and the second lithium-ion secondary battery each have a substantially cylindrical shape and a material having higher thermal conductivity than air be contained between the first lithium-ion secondary battery and the second lithium-ion secondary battery.

In the above, the storage battery preferably includes a plurality of first lithium-ion secondary batteries and an inverter. The control circuit preferably has a function of making the inverter to convert discharge current of one of the first lithium-ion secondary batteries into AC current, and to allow repeated charging and discharging on another one of the first lithium-ion secondary batteries using the AC current, when the temperature sensed by the temperature sensor is lower than the second temperature range.

In the above, the control circuit preferably has a function of detecting at least one of overcharging, overdischarging, and overcurrent to protect the first lithium-ion secondary battery and the second lithium-ion secondary battery.

In the above, the first lithium-ion secondary battery preferably contains an ionic liquid and an organic electrolyte solution.

Another embodiment of the present invention is a vehicle including the storage battery described above.

According to one embodiment of the present invention, a storage battery that operates stably regardless of the surrounding environment by controlling the temperature of a secondary battery without an external heat source can be provided. A storage battery with a lower cost can be provided. A storage battery with a lower risk of malfunction can be provided. A highly safe storage battery can be provided.

According to one embodiment of the present invention, a method for manufacturing the storage battery can be provided.

Note that the descriptions of these effects do not preclude the existence of other effects. One embodiment of the present invention does not necessarily have all these effects. Other effects will be apparent from and can be derived from the descriptions of the specification, the drawings, the claims, and the like.

### BRIEF DESCRIPTION OF THE DRAWINGS

In the accompanying drawings:

FIGS. 1A to 1E illustrate storage batteries;

FIGS. 2A and 2B illustrate storage batteries;

FIGS. 3A to 3D illustrate storage batteries;

FIGS. 4A to 4C illustrate storage batteries;

FIGS. 5A and 5B illustrate a storage battery;

FIGS. 6A and 6B are perspective views of secondary batteries, and FIG. 6C is a perspective view of a wound body;

FIG. 7A is a perspective view of a wound body, FIG. 7B illustrates an internal structure of a secondary battery, and FIG. 7C illustrates the appearance of the secondary battery;

FIGS. 8A and 8B each illustrate the appearance of a secondary battery;

FIG. 9A illustrates a positive electrode and a negative electrode, FIG. 9B illustrates a state where electrode tabs are attached, and FIG. 9C illustrates a state where the electrodes are covered with an external body;

FIG. 10A illustrates the appearance of a cylindrical secondary battery, and

FIG. 10B is an exploded perspective view of the cylindrical secondary battery;

FIG. 11A is a cross-sectional view of a semi-solid-state battery, FIG. 11B is a cross-sectional view of a positive electrode, and FIG. 11C is a cross-sectional view of an electrolyte;

FIGS. 12A to 12D are cross-sectional views of positive electrodes;

FIGS. 13A and 13B are block diagrams of a vehicle including a storage battery;

FIG. 14A illustrates an electric vehicle, FIGS. 14B and 14C illustrate examples of transport vehicles, and FIG. 14D illustrates an example of an airplane;

FIG. 15A illustrates an example of a portable storage battery, FIG. 15B illustrates an example of a stationary storage battery, and FIG. 15C illustrates an example of a storage battery connected to a solar power generation device;

FIGS. 16A and 16B each illustrate an example of a building in which a secondary battery is provided; and

FIG. 17 is a graph showing discharge capacity of a secondary battery.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

### Embodiment 1

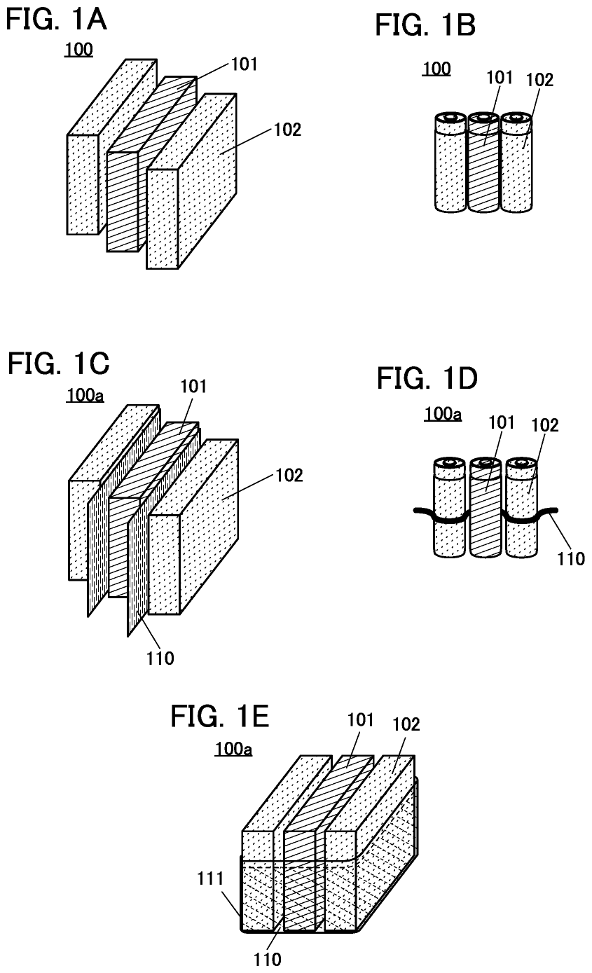

In this embodiment, examples of a storage battery of one embodiment of the present invention are described with reference to FIGS. 1A to 1E, FIGS. 2A and 2B, and FIGS. 3A to 3D.

FIG. 1A illustrates an example of a storage battery 100 of one embodiment of the present invention. The storage battery 100 includes a lithium-ion secondary battery 101 and a lithium-ion secondary battery 102 adjacent to each other. The lithium-ion secondary battery 101 and the lithium-ion secondary battery 102 are preferably in contact with each other.

The lithium-ion secondary battery 101 can be charged and discharged at low temperatures. The low temperature is, for example, lower than or equal to 0° C., preferably lower than or equal to −20° C. To enable charging and discharging at low temperatures, the lithium-ion secondary battery 101 preferably contains an ionic liquid as an electrolyte solution. A molecular crystalline electrolyte, a semi-solid-state electrolyte, or an all-solid-state electrolyte is preferably contained as an electrolyte. Lithium titanate is preferably contained as a negative electrode active material. One or more of these features can be employed.

The lithium-ion secondary battery 102 has good charge and discharge characteristics and good cycle performance in a middle temperature range. The middle temperature range is, for example, a range from 0° C. to 45° C. To have good charge and discharge characteristics in a middle temperature range, the lithium-ion secondary battery 102 preferably contains an organic solvent as an electrolyte solution. The use of an organic solvent as the electrolyte solution enables lower-cost manufacturing.

With such a structure, the lithium-ion secondary battery 102 can be heated using heat generated by charging and discharging of the lithium-ion secondary battery 101 as an internal heat source in a low temperature environment. When heated to reach or be close to a middle temperature range, good charge and discharge characteristics of the lithium-ion secondary battery 102 can be utilized.

In this specification and the like, the expression “A and B are adjacent to each other” means that A and B are not necessarily in contact with each other but are at a distance close enough to allow thermal conduction. For example, when A and B are in the same container, box, or bundle, A and B can be regarded as being adjacent to each other.

An ionic liquid refers to a salt present in a liquid state, which is also called a room-temperature molten salt or a low-melting-point molten salt. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion. Using one or more of these materials improves the charge and discharge characteristics at low temperatures in some cases. Since the ionic liquid is less likely to burn and volatilize, it is possible to prevent the secondary battery from exploding or catching fire even when the internal temperature increases due to an internal short circuit or overcharging, for example.

A molecular crystalline electrolyte refers to a material having a crystal structure and lithium-ion conductivity, in which a plurality of molecules are bonded by molecular interactions. The molecular crystalline electrolyte is preferably a composite material of a first compound and a second compound, for example. As the first compound, a nitrile solvent can be used; for example, one or more kinds of acetonitrile, succinonitrile, glutaronitrile, and adiponitrile can be used. As the second compound, one or more kinds of lithium bis(fluorosulfonyl)imide (Li(FSO₂)₂N, abbreviation: LiFSI), lithium bis(trifluoromethanesulfonyl)imide (Li(CF₃SO₂)₂N, abbreviation: LiTFSI), and lithium bis(pentafluoroethanesulfonyl)imide (Li(C₂F₅SO₂)₂N, abbreviation: LiBETI) can be used. The molecular crystalline electrolyte can also serve as a binder, and thus can contribute to a higher electrode density.

A semi-solid-state electrolyte refers to a dry (or intrinsic) polymer electrolyte or a polymer gel electrolyte. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used to satisfy the above properties.

When a semi-solid-state electrolyte is used, safety against liquid leakage and the like is improved. Moreover, the secondary battery can be thinner and more lightweight.

As a polymer gel electrolyte, a silicone gel, an acrylic gel, an acrylonitrile gel, a polyethylene oxide-based gel, a polypropylene oxide-based gel, a fluorine-based polymer gel, or the like can be used.

Examples of the dry polymer electrolyte include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

In this specification and the like, an all-solid-state electrolyte refers to a solid having lithium-ion conductivity. For example, as the electrolyte of the lithium-ion secondary battery 101, a sulfide-based solid electrolyte, an oxide-based solid electrolyte, a halide-based solid electrolyte, or the like can be used.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material having a perovskite crystal structure (e.g., La_{2/3-x}Li₃ₓTiO₃), a material having a NASICON crystal structure (e.g., Li₁₋ₓAlₓTi₂₋ₓ(PO₄)₃), a material having a garnet crystal structure (e.g., Li₇La₃Zr₂O₁₂), a material having a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter LATP) is preferable because LATP contains aluminum and titanium, each of which is the element the positive electrode active material used in a secondary battery of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

Since a molecular crystalline electrolyte, a semi-solid-state electrolyte, and an all-solid-state electrolyte are also less likely to burn and volatilize, it is possible to prevent the secondary battery from exploding or igniting even when the internal temperature increases due to an internal short circuit or overcharging, for example.

As the organic solvent contained in the electrolyte solution of the lithium-ion secondary battery 102, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

As the electrolyte dissolved in the above organic solvent, one of lithium salts such as LiPF₆, LiClO₄, LiAsF₆, LiBF₄, LiAlCl₄, LiSCN, LiBr, LiI, Li₂SO₄, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolyte solution used for the lithium-ion secondary battery 101 and the lithium-ion secondary battery 102 is preferably highly purified and contains small numbers of dust particles and elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate (VC), propane sultone (PS), tert-butylbenzene (TBB), fluoroethylene carbonate (FEC), lithium bis(oxalate)borate (LiBOB), or a dinitrile compound like succinonitrile or adiponitrile may be added to the electrolyte solution. The concentration of the material to be added in the whole solvent is, for example, higher than or equal to 0.1 wt % and lower than or equal to 5 wt %. It is particularly preferable to use VC or LiBOB because it facilitates film formation.

FIG. 1A illustrates an example in which the lithium-ion secondary battery 101 and the lithium-ion secondary battery 102 included in the storage battery 100 are rectangular solids and placed such that their largest surfaces face each other. Such a placement can increase the efficiency of thermal conduction.

A rectangular solid is a hexahedron whose surfaces are all rectangular. In this specification and the like, these rectangular surfaces are not necessarily strictly rectangular nor completely flat. For example, a certain surface may be provided with a positive electrode terminal and/or a negative electrode terminal, or may have unevenness for higher strength. Such a shape may be referred to as a substantially rectangular solid.

FIG. 1B illustrates an example in which the lithium-ion secondary battery 101 and the lithium-ion secondary battery 102 included in the storage battery 100 have cylindrical shapes.

In this specification and the like, the cylindrical shape refers to a solid whose top and bottom surfaces are circular. These circular surfaces are not necessarily strictly circular nor completely flat. For example, the top or bottom surface may be provided with a positive electrode terminal and/or a negative electrode terminal, or may have unevenness for higher strength. Such a shape may be referred to as a substantially cylindrical shape.

FIG. 1C illustrates an example of a storage battery 100a including a thermal conductor 110 that has a foil shape in addition to the lithium-ion secondary battery 101 and the lithium-ion secondary battery 102 that are rectangular solids. FIG. 1D illustrates an example of the storage battery 100a including the thermal conductor 110 that has a wire shape in addition to the lithium-ion secondary battery 101 and the lithium-ion secondary battery 102 that have cylindrical shapes. FIG. 1E illustrates an example of the storage battery 100a including the thermal conductor 110 that is a liquid and a container 111 in addition to the lithium-ion secondary battery 101 and the lithium-ion secondary battery 102 that are rectangular solids.

By including the thermal conductor 110 between the lithium-ion secondary battery 101 and the lithium-ion secondary battery 102, each of the storage batteries 100a illustrated in FIGS. 1C to 1E can have higher efficiency of thermal conduction.

The thermal conductor 110 has higher thermal conductivity than the air. For example, a metal foil such as a copper foil, a metal wire, a graphite sheet, silicone oil, or an antifreeze solution such as ethylene glycol can be used. These may be used in combination. For example, a metal tube in which a liquid having high thermal conductivity is circulated may be used. In the case where the secondary batteries and the liquid thermal conductor 110 are in contact with each other as in FIG. 1E, the thermal conductor 110 having an insulating property is preferably used for higher safety.

Although FIGS. 1A to 1E illustrate examples in which two kinds of lithium-ion secondary batteries that differ in the operating temperature range are included, one embodiment of the present invention is not limited thereto. Three or more kinds of lithium-ion secondary batteries that differ in the operating temperature range may be included.

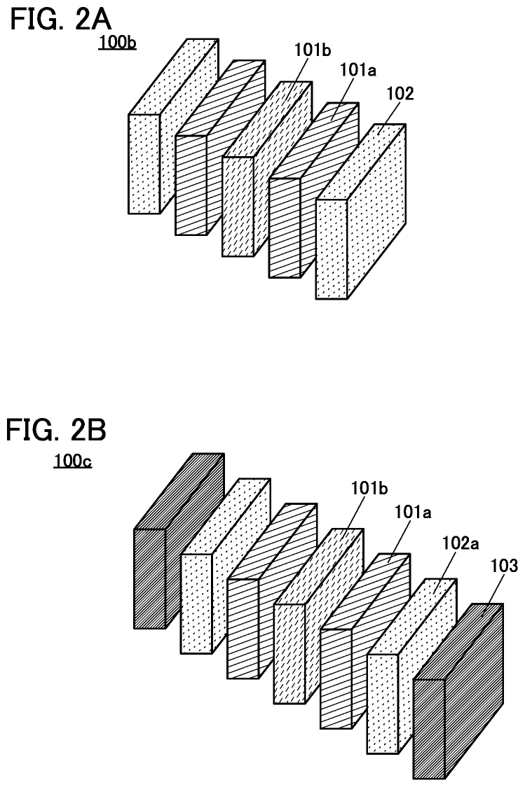

FIG. 2A illustrates an example of a storage battery 100b including a lithium-ion secondary battery 101a, a lithium-ion secondary battery 101b, and the lithium-ion secondary battery 102. The lithium-ion secondary battery 101a operates in a low temperature range, e.g., at lower than or equal to 0° C. The lithium-ion secondary battery 101b operates in an extremely low temperature range, e.g., at lower than or equal to −20° C. The lithium-ion secondary battery 102 has good charge and discharge characteristics in a middle temperature range.

FIG. 2B illustrates an example of a storage battery 100c including the lithium-ion secondary battery 101a, the lithium-ion secondary battery 101b, a lithium-ion secondary battery 102a, and a lithium-ion secondary battery 103. The lithium-ion secondary battery 101a operates in a low temperature range, e.g., at lower than or equal to 0° C. The lithium-ion secondary battery 101b operates in an extremely low temperature range, e.g., at lower than or equal to −20° C. The lithium-ion secondary battery 102a has good charge and discharge characteristics and good cycle performance in a moderately low temperature range, e.g., a temperature range from 0° C. to 25° C. The lithium-ion secondary battery 103 has good charge and discharge characteristics and good cycle performance in a moderately high temperature range, e.g., a temperature range from 25° C. to 50° C.

The secondary batteries that differ in the operating temperature range can be fabricated, for example, by changing the mixture ratio of an ionic liquid to an organic solvent in an electrolyte solution. For example, the lithium-ion secondary battery 101b that operates in an extremely low temperature range can use only an ionic liquid as the electrolyte solution, and the lithium-ion secondary battery 101a that operates in a low temperature range can use a mixture of an ionic liquid and an organic solvent as the electrolyte solution. In addition, for example, the lithium-ion secondary battery 103 that operates in a moderately high temperature range can use an ionic liquid, a semi-solid-state electrolyte, and/or an all-solid-state electrolyte as the electrolyte solution and/or the electrolyte. By having a higher proportion of a conductive material than a lithium-ion secondary battery that operates in a lower temperature range, a lithium-ion secondary battery can have lower internal resistance and better characteristics in a moderately high temperature range. It is further preferable to use a material having high conductivity, such as a carbon nanotube, graphene, or a graphene compound, as the conductive material.

With such a structure, heat generated by charging and discharging of the lithium-ion secondary battery 101b can be used as an internal heat source for heating the other secondary batteries in an extremely low temperature environment, for example. Moreover, the secondary batteries can exhibit good charge and discharge characteristics and good cycle performance in and above a middle temperature range. Thus, the storage battery can operate in a wider temperature range.

In the storage battery 100, the lithium-ion secondary batteries 102 are preferably placed so that the lithium-ion secondary battery 101 that operates in a low temperature environment is surrounded by or interposed between the lithium-ion secondary batteries 102. In other words, the lithium-ion secondary battery 101 is preferably placed on the inner side.

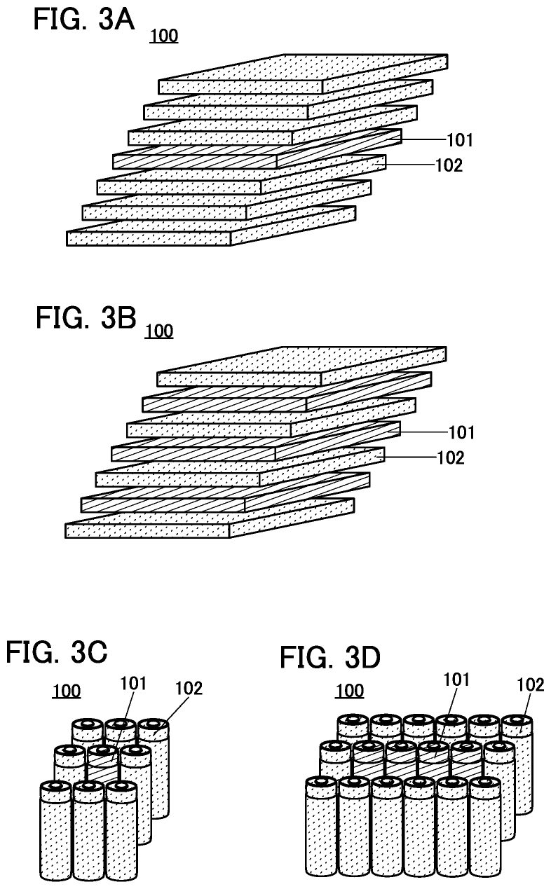

FIG. 3A illustrates an example of the storage battery 100 in which one lithium-ion secondary battery 101 is interposed among six lithium-ion secondary batteries 102. FIG. 3B illustrates an example of the storage battery 100 in which three lithium-ion secondary batteries 101 and four lithium-ion secondary batteries 102 are placed alternately. FIG. 3C illustrates an example of the storage battery 100 in which one lithium-ion secondary battery 101 is surrounded by eight lithium-ion secondary batteries 102. FIG. 3D illustrates an example of the storage battery 100 in which four lithium-ion secondary batteries 101 are surrounded by fourteen lithium-ion secondary batteries 102.

With such a structure, heat generated by the lithium-ion secondary battery 101 can be efficiently conducted to the lithium-ion secondary batteries 102. In addition, the storage battery can operate in a wide temperature range even with a small number of lithium-ion secondary batteries 101, which are factors of cost increase.

Similarly, in the case where three or more kinds of lithium-ion secondary batteries that differ in the operating temperature range are included, a secondary battery that operates in a lower temperature range is preferably placed on the inner side.

It is preferable that the storage battery 100 further include a temperature sensor and a control circuit. The temperature sensor has a function of sensing the temperature of at least the lithium-ion secondary battery 102. The control circuit preferably has a function of making the lithium-ion secondary battery 101 generate heat so that the lithium-ion secondary battery 102 is heated to the operating temperature range, when the temperature of the lithium-ion secondary battery 102 is lower than the operating temperature range.

For example, in the case where the storage battery 100 includes the lithium-ion secondary battery 101 with an operating temperature range from −20° C. to 0° C., the lithium-ion secondary battery 102 with an operating temperature range from 0° C. to 45° C., the temperature sensor, and the control circuit, the control circuit preferably has a function of making the lithium-ion secondary battery 101 generate heat so that the lithium-ion secondary battery 102 is heated to the range from 0° C. to 45° C., when the temperature of the lithium-ion secondary battery 102 sensed by the temperature sensor is lower than 0° C.

When the temperature of the lithium-ion secondary battery 102 is within the operating temperature range, the lithium-ion secondary battery 101 may be operated, i.e., charged or discharged, or may not be operated. For example, the control circuit may have a function of making the lithium-ion secondary battery 101 operate when the temperature of the lithium-ion secondary battery 102 is lower than 25° C. and not making the lithium-ion secondary battery 101 operate when the temperature of the lithium-ion secondary battery 102 is higher than or equal to 25° C.

There is no particular limitation on the method for making the lithium-ion secondary battery 101 generate heat. The lithium-ion secondary battery 101 generates heat due to normal charging and discharging.

The storage battery 100 may further include a plurality of lithium-ion secondary batteries 101 and an inverter. With such a structure, discharge current of one lithium-ion secondary battery 101 can be converted into AC current by the inverter, and another lithium-ion secondary battery 101 can be repeatedly charged and discharged using the AC current. This operation also makes the lithium-ion secondary battery 101 generate heat.

For example, in the case where the storage battery 100 includes two or more lithium-ion secondary batteries 101 with an operating temperature range from −20° C. to 0° C., the lithium-ion secondary battery 102 with an operating temperature range from 0° C. to 45° C., the temperature sensor, the control circuit, and the inverter, the control circuit preferably has a function of controlling the temperature of the lithium-ion secondary battery 102 to the range from 0° C. to 45° C. when the temperature of the lithium-ion secondary battery 102 sensed by the temperature sensor is lower than 0° C., in the following manner: discharge current of one lithium-ion secondary battery 101 is converted into AC current by the inverter, another lithium-ion secondary battery 101 is repeatedly charged and discharged using the AC current, and the lithium-ion secondary battery 102 is heated using the generated heat.

The control circuit further preferably has a function of detecting at least one of overcharging, overdischarging, and overcurrent to protect the lithium-ion secondary battery 101 and the lithium-ion secondary battery 102, in addition to the temperature controlling function.

In the storage battery 100, a structure may be employed in which the lithium-ion secondary battery 102 does not perform discharging to the outside when the temperature is lower than the operating temperature range, and starts to perform discharging to the outside after heated to the operating temperature range by the lithium-ion secondary battery 101. In this case, it can be said that the lithium-ion secondary battery 101 has a function of an auxiliary heat source.

Although the storage battery including two kinds of lithium-ion secondary batteries is used as an example in the description of the temperature sensor and the control circuit, one embodiment of the present invention is not limited thereto. The functions of the temperature sensor and the control circuit can be set with reference to the above description, even in the case of a storage battery including three or more kinds of lithium-ion secondary batteries, the temperature sensor, and the control circuit.

This embodiment can be implemented in combination with any of the other embodiments.

### Embodiment 2

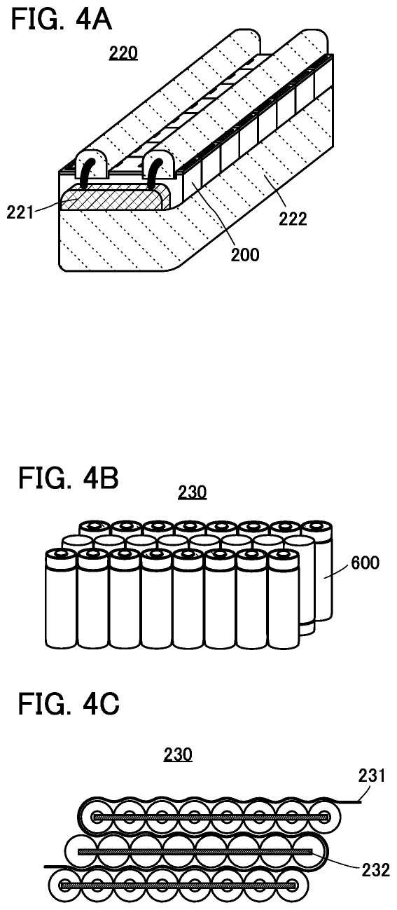

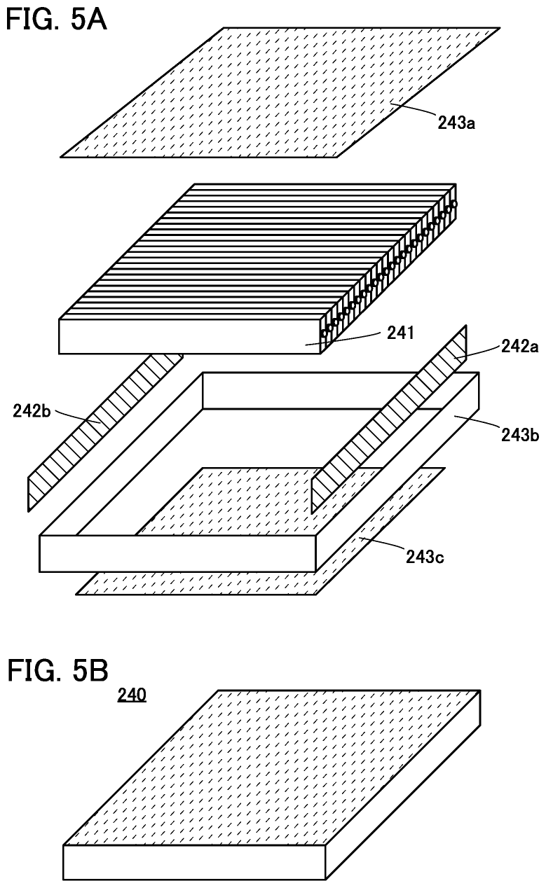

In this embodiment, more specific examples of a storage battery of one embodiment of the present invention are described with reference to FIGS. 4A to 4C and FIGS. 5A and 5B.

FIG. 4A illustrates an example of a storage battery of one embodiment of the present invention. A storage battery 220 includes a plurality of secondary batteries 200, a case 222 that stores the plurality of secondary batteries 200, and a control circuit 221. The above embodiment can be referred to for the combination of the plurality of secondary batteries 200.

FIG. 4B is a perspective view of a storage battery of one embodiment of the present invention, and FIG. 4C is a top view of the storage battery of one embodiment of the present invention. A storage battery 230 includes a plurality of secondary batteries 600 and a thermal conductor 231. For simplicity, FIG. 4B only illustrates the secondary batteries 600. Some of the secondary batteries 600 are electrically connected to each other through a wiring 232. The thermal conductor 231 illustrated in FIG. 4C is a metal tube in which a liquid having high thermal conductivity is circulated. By providing the thermal conductor 231 so as to run between the secondary batteries 600 as illustrated, the efficiency of thermal conduction can be increased. The above embodiment can be referred to for the combination of the plurality of secondary batteries 600.

FIG. 5A illustrates a structure of a storage battery of one embodiment of the present invention, and FIG. 5B is a perspective view of the storage battery of one embodiment of the present invention. A storage battery 240 includes a plurality of secondary batteries 241, a conductive material 242a and a conductive material 242b that are electrically connected to the plurality of secondary batteries 241, and a holding material 243a, a holding material 243b, and a holding material 243c for storing the secondary batteries and the conductive materials. Part of the holding materials is preferably provided with a positive electrode terminal and a negative electrode terminal that are electrically connected to the conductive materials 242a and 242b. The above embodiment can be referred to for the combination of the plurality of secondary batteries 241.

The storage battery 240 in which a plurality of secondary batteries having an elongated shape, such as the secondary batteries 241, are arranged can have higher strength.

This embodiment can be implemented in combination with any of the other embodiments.

### Embodiment 3

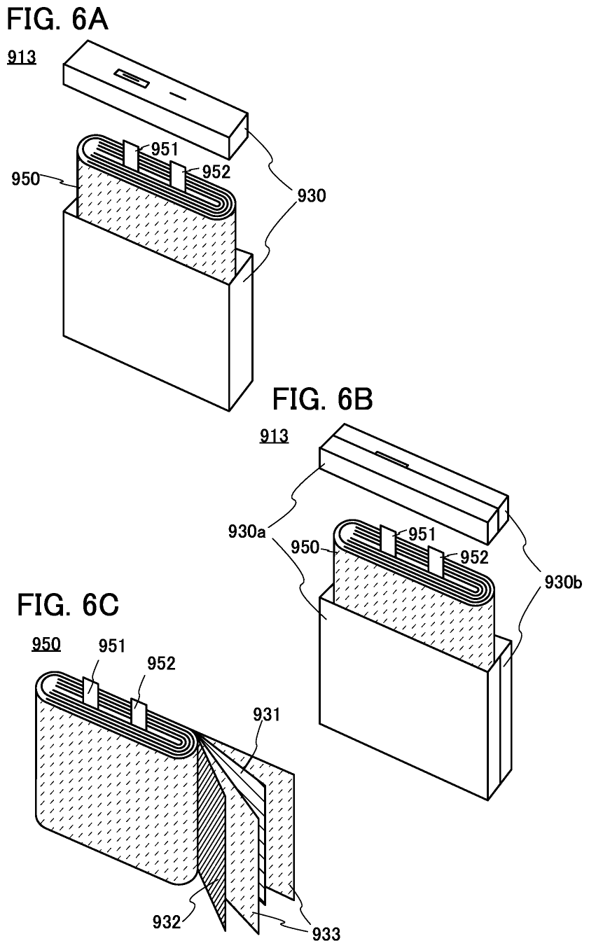

In this embodiment, examples of a secondary battery that can be used for a storage battery of one embodiment of the present invention and examples of the materials are described with reference to FIGS. 6A to 6C, FIGS. 7A to 7C, FIGS. 8A and 8B, FIGS. 9A to 9C, and FIGS. 10A and 10B.

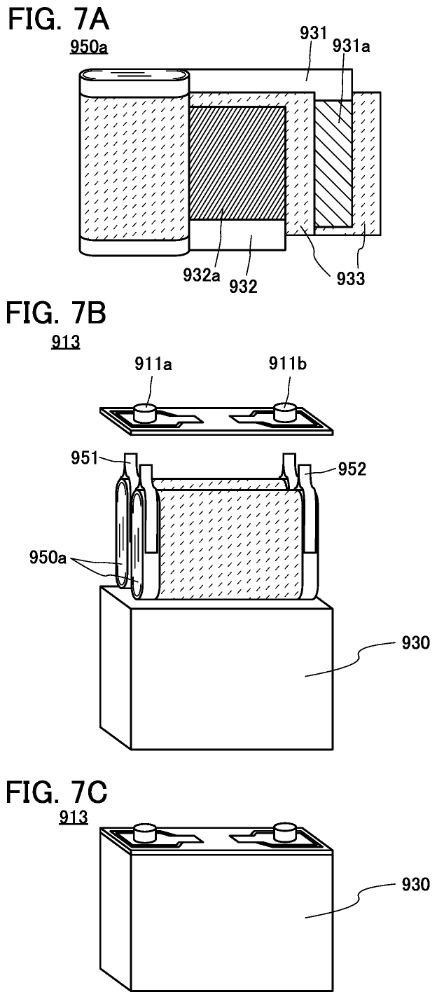

First, structure examples of a secondary battery that is a substantially rectangular solid are described with reference to FIGS. 6A to 6C and FIGS. 7A to 7C. A secondary battery 913 illustrated in FIG. 6A includes a wound body 950 provided with a terminal 951 and a terminal 952 inside a housing 930. The terminal 952 is in contact with the housing 930. The use of an insulator or the like inhibits contact between the terminal 951 and the housing 930. Note that in FIG. 6A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 6B, the housing 930 in FIG. 6A may be formed using a plurality of materials. For example, in the secondary battery 913 in FIG. 6B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 6C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

The secondary battery 913 may include a wound body 950a as illustrated in FIGS. 7A to 7C. The wound body 950a illustrated in FIG. 7A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 7B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b. As illustrated in FIG. 7B, two wound bodies 950a are stored in one housing 930.

As illustrated in FIG. 7C, the wound body 950a and the like are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 7B, the secondary battery 913 may include a plurality of wound bodies 950a. The use of the plurality of wound bodies 950a enables the secondary battery 913 to have higher charge and discharge capacity. The description of the secondary battery 913 in FIGS. 6A to 6C can be referred to for the other components of the secondary battery 913 in FIGS. 7A and 7B.

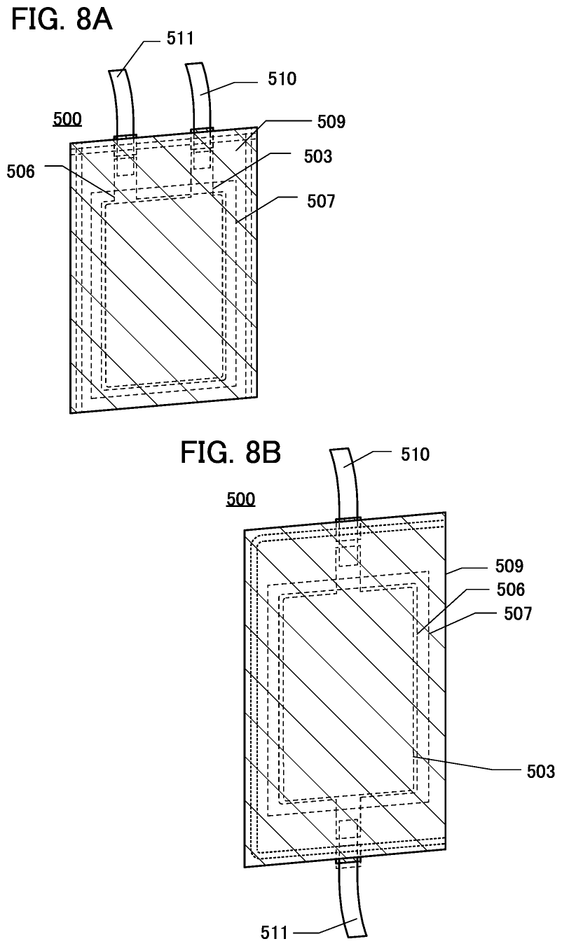

Next, examples of the appearance of a laminated secondary battery are illustrated in FIGS. 8A and 8B. Secondary batteries 500 illustrated in FIGS. 8A and 8B each include a positive electrode 503, a negative electrode 506, a separator 507, an exterior body 509, a positive electrode lead electrode 510, and a negative electrode lead electrode 511.

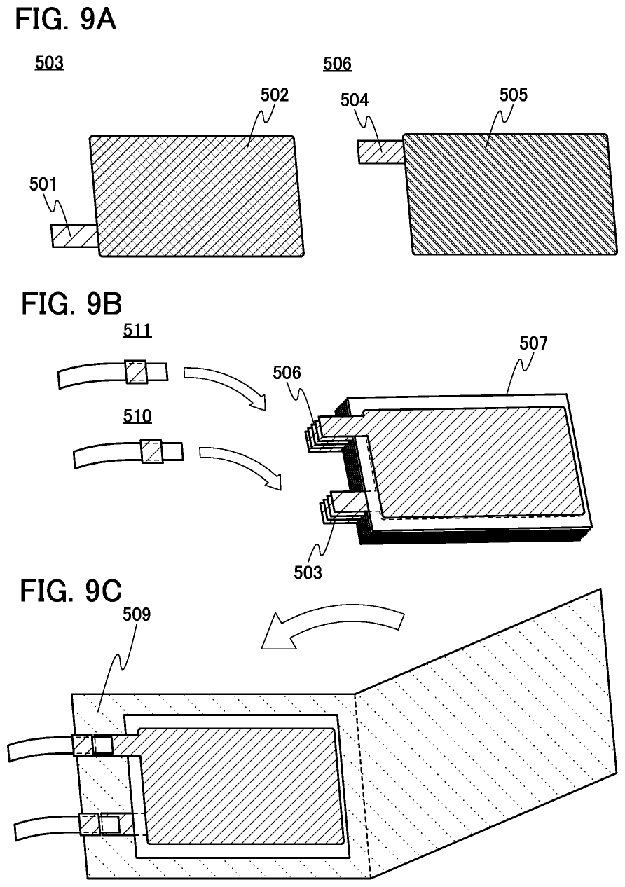

FIG. 9A illustrates the appearances of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and shapes of the tab regions included in the positive electrode and negative electrode are not limited to those illustrated in FIG. 9A.

Here, an example of a fabricating method of the laminated secondary battery whose appearance is illustrated in FIG. 8A will be described with reference to FIGS. 9B and 9C.

First, the negative electrode 506, the separator 507, and the positive electrode 503 are stacked. FIG. 9B illustrates a stack including the negative electrode 506, the separator 507, and the positive electrode 503. The secondary battery described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

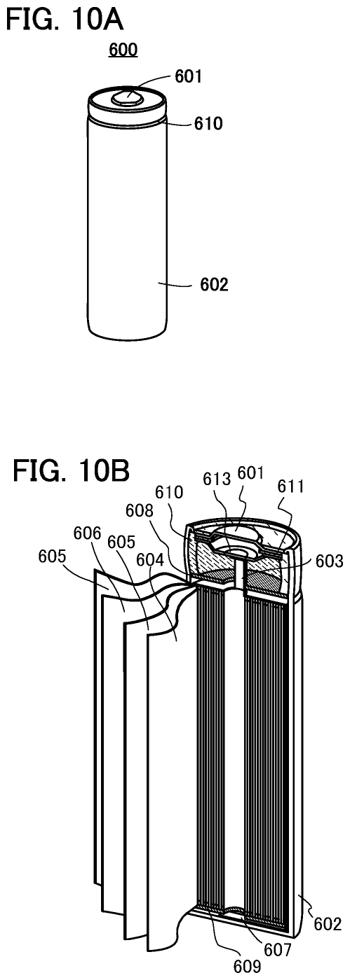

Next, an example of a cylindrical secondary battery is described with reference to FIGS. 10A and 10B. A cylindrical secondary battery 600 includes, as illustrated in FIG. 10A, a positive electrode cap (battery lid) 601 on the top surface and a battery can (outer can) 602 on the side and bottom surfaces. The positive electrode cap 601 and the battery can (outer can) 602 are insulated from each other by a gasket (insulating gasket) 610.

FIG. 10B schematically illustrates a cross section of the cylindrical secondary battery. Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to a solvent, such as nickel, aluminum, or titanium, an alloy of such a metal, or an alloy of such a metal and another metal (e.g., stainless steel) can be used. The battery can 602 are preferably covered with nickel, aluminum, or the like in order to prevent corrosion due to the solvent. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte (not illustrated). As the nonaqueous electrolyte, an electrolyte similar to that for the secondary battery in the above embodiment can be used.

Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold value. A PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

### [Negative Electrode]

The negative electrode includes a negative electrode active material layer and a negative electrode current collector. The negative electrode active material layer may contain a conductive material and a binder.

### <Negative Electrode Active Material>

As a negative electrode active material, for example, an alloy-based material and/or a carbon-based material can be used.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, it is preferable that x be 1 or have an approximate value of 1. For example, x is preferably 0.2 or more and 1.5 or less, further preferably 0.3 or more and 1.2 or less.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into the graphite (while a lithium-graphite intercalation compound is generated). For this reason, a lithium-ion secondary battery can have a high operating voltage. In addition, graphite is preferable because of its advantages such as a relatively high capacity per unit volume, relatively small volume expansion, low cost, and higher level of safety than that of a lithium metal.

As the negative electrode active material, an oxide such as titanium dioxide (TiO₂), lithium titanate (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of its high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

A typical example of the conductive material that can be contained in the negative electrode active material layer is carbon black (e.g., furnace black, acetylene black, and graphene). Graphene or a graphene compound may be used as the conductive material.

Graphene, which has electrically, mechanically, or chemically remarkable characteristics, is a carbon material that is expected to be applied to a variety of fields, such as field-effect transistors and solar batteries.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, and the like. A graphene compound contains carbon, has a plate-like shape, a sheet-like shape, or the like, and has a two-dimensional structure formed of six-membered rings of carbon atoms. A graphene compound is preferably bent. A graphene compound may also be referred to as a carbon sheet. A graphene compound preferably includes a functional group. A graphene compound may be rounded like a carbon nanofiber.

The graphene and graphene compound may have excellent electrical characteristics of high conductivity and excellent physical properties of high flexibility and high mechanical strength. The graphene and graphene compound have a sheet-like shape. The graphene and graphene compound sometimes have a curved surface, thereby enabling low-resistant surface contact. Furthermore, the graphene and graphene compound sometimes have extremely high conductivity even with a small thickness, in which case a conductive path can be efficiently formed in an active material layer with a small amount of the graphene and graphene compound. Hence, the use of the graphene and graphene compound as the conductive material can increase the area where the active material and the conductive material are in contact with each other. Note that the graphene or graphene compound preferably clings to at least part of an active material. The graphene or a graphene compound preferably overlays at least part of the active material. The shape of the graphene or graphene compound preferably conforms to at least part of the shape of the active material. The shape of the active material means, for example, an uneven surface of a single active material particle or an uneven surface formed by a plurality of active material particles. The graphene or graphene compound preferably surrounds at least part of an active material. The graphene or graphene compound may have a hole.

As the binder that can be contained in the negative electrode active material layer, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Examples of the binder include fluorine rubber. In this specification and the like, a binder refers to a high molecular compound mixed only for binding an active material, a conductive material, and the like onto a current collector.

### <Negative Electrode Current Collector>

For the negative electrode current collector, a material similar to that for the positive electrode current collector can be used. Note that a material that is not alloyed with carrier ions of lithium or the like is preferably used for the negative electrode current collector.

### [Separator]

The separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Positive Electrode]

The positive electrode includes a positive electrode active material layer and a positive electrode current collector. The positive electrode active material layer may contain a conductive material and a binder.

### <Positive Electrode Active Material>

The positive electrode active material preferably includes a metal (hereinafter, an element A) serving as a carrier ion. Examples of the element A include alkaline metals such as lithium, sodium, and potassium and Group 2 elements such as calcium, beryllium, and magnesium.

In the positive electrode active material, carrier ions are extracted from the positive electrode active material due to charging. A larger number of the extracted elements A mean a larger number of ions contributing to the capacity of a secondary battery, i.e., higher capacity. Meanwhile, a large number of the extracted elements A easily cause collapse of the crystal structure of a compound contained in the positive electrode active material. The collapse of the crystal structure of the positive electrode active material may lead to a decrease in the discharge capacity due to charge and discharge cycles. When the positive electrode active material contains an element X, collapse of a crystal structure that would be caused by carrier ion extraction in charging of a secondary battery might be inhibited. Part of the element X substitutes for the element A, for example. An element such as magnesium, calcium, zirconium, lanthanum, or barium can be used as the element X As another example, an element such as copper, potassium, sodium, or zinc can be used as the element X. Two or more of the elements described above as the element X may be used in combination.

The positive electrode active material preferably contains halogen in addition to the element X The positive electrode active material preferably contains halogen such as fluorine or chlorine. When the positive electrode active material contains the halogen, substitution of the element X for the element A is promoted in some cases.

When the positive electrode active material contains the element X or contains halogen in addition to the element X, the electrical conductivity in the surface of the positive electrode active material is reduced in some cases.

The positive electrode active material contains a metal whose valence number changes due to charging and discharging of a secondary battery (hereinafter an element M). The element M is a transition metal, for example. The positive electrode active material preferably contains at least one of cobalt, nickel, and manganese, particularly cobalt, as the element M. The positive electrode material may contain, in place of the element M, an element with no valence change that can have the same valence as the element M, such as aluminum, specifically a trivalent main group element, for example. The element X may substitute for the element M, for example. In the case where the positive electrode active material is an oxide, the element X may substitute for oxygen.

As the positive electrode active material, a lithium composite oxide having a layered rock-salt crystal structure is preferably used, for example. Specifically, as the lithium composite oxide having a layered rock-salt crystal structure, lithium cobalt oxide, lithium nickel oxide, a lithium composite oxide containing nickel, manganese, and cobalt, or a lithium composite oxide containing nickel, cobalt, and aluminum can be used, for example. Moreover, such a positive electrode active material is preferably represented by a space group R-3m.

In the positive electrode active material having a layered rock-salt crystal structure, increasing the charge depth may cause collapse of a crystal structure. Here, collapse of a crystal structure refers to displacement of a layer, for example. In the case where collapse of a crystal structure is irreversible, the capacity of a secondary battery might be decreased by repeated charging and discharging.

When the positive electrode active material contains the element X, the displacement of a layer can be suppressed even when the charge depth is increased, for example. By suppressing the displacement, a change in volume due to charging and discharging can be small. Accordingly, the positive electrode active material can achieve excellent cycle performance. In addition, the positive electrode active material can have a stable crystal structure in a high-voltage charged state. Thus, in the positive electrode active material, a short circuit is less likely to occur while the high-voltage charged state is maintained. This is preferable because the safety is further improved.

The positive electrode active material has a small crystal-structure change and a small volume difference per the same number of transition metal atoms between a sufficiently discharged state and a high-voltage charged state.

The positive electrode active material is represented by the chemical formula AM_{y}O_{z} (y>0, z>0) in some cases. For example, lithium cobalt oxide is represented by LiCoO₂ in some cases. As another example, lithium nickel oxide is represented by LiNiO₂ in some cases.

The number of element X atoms is preferably 0.001 to 0.1 times, further preferably larger than 0.01 times and less than 0.04 times, still further preferably approximately 0.02 times the number of element M atoms. The concentration of the element X described here may be a value obtained by element analysis on the entire particle of the positive electrode active material using ICP-MS or the like, or may be a value based on the ratio of the raw materials mixed in the process of forming the positive electrode active material, for example.

In the case where cobalt and nickel are contained as the element M, the proportion Ni/(Co+Ni), the proportion of nickel atoms (Ni) to the sum of cobalt atoms and nickel atoms (Co+Ni), is preferably less than 0.1, further preferably less than or equal to 0.075.

The positive electrode active material is not limited to the materials described above.

For example, a composite oxide having a spinel crystal structure can be used as the positive electrode active material. As another example, a polyanionic material can be used as the positive electrode active material. Examples of the polyanionic material include a material having an olivine crystal structure and a material having a NASICON structure. As another example, a material containing sulfur can be used as the positive electrode active material.

As a material having a spinel crystal structure, a composite oxide represented by LiM₂O₄ can be used, for example. It is preferable that Mn be contained as the element M. For example, LiMn₂O₄ can be used. It is preferable that Ni be contained as the element M in addition to Mn because the discharge voltage and the energy density of the secondary battery are improved in some cases. It is preferable to add a small amount of lithium nickel oxide (LiNiO₂ or LiNi₁₋ₓMₓO₂ (M is Co, Al, or the like)) to a lithium-containing material having a spinel crystal structure which contains manganese, such as LiMn₂O₄, because the characteristics of the secondary battery can be improved.

As the polyanionic material, a composite oxide containing oxygen, a metal A, a metal M, and an element Z can be used, for example. The metal A is one or more of Li, Na, and Mg, the metal M is one or more of Fe, Mn, Co, Ni, Ti, V, and Nb, and the element Z is one or more of S, P, Mo, W, As, and Si.

As a material having an olivine crystal structure, a composite material (LiMPO₄ (general formula) (M is one or more of Fe(II), Mn(II), Co(II), and Ni(II))) can be used. Typical examples of the general formula LiMPO₄ are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

Alternatively, a composite material such as Li(₂₋ⱼ)MSiO₄ (general formula) (M is one or more of Fe(II), Mn(II), Co(II), and Ni(II); 0≤j≤2) can be used as the positive electrode active material. Typical examples of the general formula Li₍₂₋ⱼ₎MSiO₄ are lithium compounds such as Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≤1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≤1, 0<m<1, 0<n<1, and 0<q<1), and Li₍₂₋ⱼ₎FeᵣNiₛCoₜMnᵤSiO₄ (r+s+t+u≤1, 0<r<1, 0<s<1, 0<t<1, and 0<u<1).

Still alternatively, a NASICON compound represented by AₓM₂(XO₄)₃ (general formula) (A=Li, Na, or Mg, M=Fe, Mn, Ti, V, or Nb, X=S, P, Mo, W, As, or Si) can be used. Examples of the NASICON compound are Fe₂(MnO₄)₃, Fe₂(SO₄)₃, and Li₃Fe₂(PO₄)₃. A compound represented by Li₂MPO₄F, Li₂MP₂O₇, or Li₅MO₄ (general formula) (M is Fe or Mn) can be used as the positive electrode active material.

Further alternatively, a perovskite fluoride such as NaFeF₃ and FeF₃, a metal chalcogenide (a sulfide, a selenide, or a telluride) such as TiS₂ and MoS₂, an oxide having an inverse spinel structure such as LiMVO₄, a vanadium oxide (V₂O₅, V₆O₁₃, LiV₃O₈, or the like), a manganese oxide, an organic sulfur compound, or the like may be used as the positive electrode active material.

A borate-based material represented by a general formula LiMNO₃ (M is Fe(II), Mn(II), or Co(II)) may be used as the positive electrode active material.

As a material containing sodium, for example, an oxide containing sodium, such as NaFeO₂, Na_{2/3}[Fe_{1/2}Mn_{1/2}]O₂, Na_{2/3}[Ni_{1/3}Mn_{2/3}]O₂, Na₂Fe₂(SO₄)₃, Na₃V₂(PO₄)₃, Na₂FePO₄F, NaVPO₄F, NaMPO₄ (M is Fe(II), Mn(II), Co(II), or Ni(II)), Na₂FePO₄F, or Na₄Co₃(PO₄)₂P₂O₇ may be used.

As the positive electrode active material, a lithium-containing metal sulfide may be used. Examples of the lithium-containing metal sulfide include Li₂TiS₃ and Li₃NbS₄.

As the positive electrode active material used in this embodiment, a mixture of two or more of the above-listed materials may be used.

This embodiment can be freely combined with any of the other embodiments.

### Embodiment 4

This embodiment describes an example of fabricating a semi-solid-state battery as the secondary battery that operates at low temperatures, which is described in Embodiment 1.

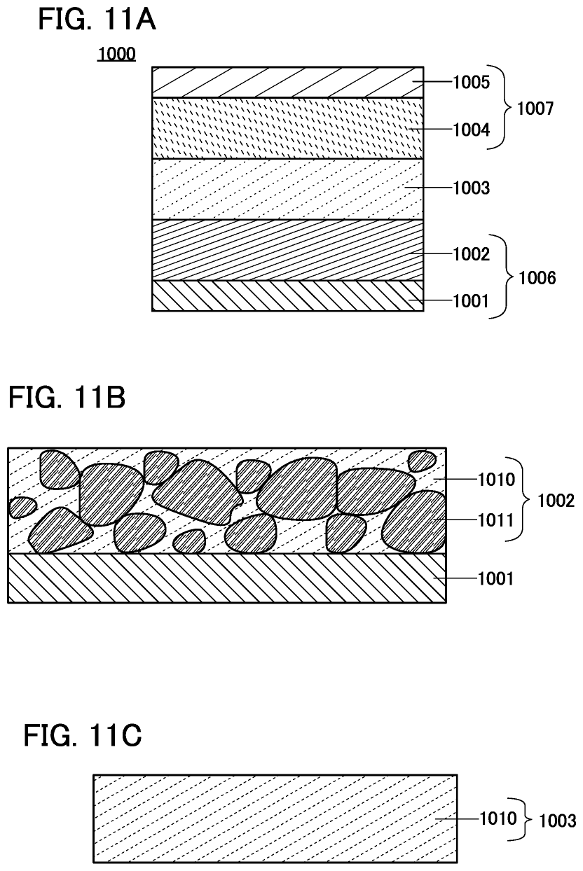

FIG. 11A is a schematic cross-sectional view of a secondary battery 1000 of one embodiment of the present invention. The secondary battery 1000 includes a positive electrode 1006, an electrolyte layer 1003, and a negative electrode 1007. The positive electrode 1006 includes a positive electrode current collector 1001 and a positive electrode active material layer 1002. The negative electrode 1007 includes a negative electrode current collector 1005 and a negative electrode active material layer 1004.

FIG. 11B is a schematic cross-sectional view of the positive electrode 1006. The positive electrode active material layer 1002 of the positive electrode 1006 contains a positive electrode active material 1011, an electrolyte 1010, and a conductive material (also referred to as a conductive additive). The electrolyte 1010 contains a lithium-ion conductive polymer and a lithium salt. It is preferable that the positive electrode active material layer 1002 do not contain a binder.

FIG. 11C is a schematic cross-sectional view of the electrolyte layer 1003. The electrolyte layer 1003 contains the electrolyte 1010 containing a lithium-ion conductive polymer and a lithium salt.

In this specification and the like, the lithium-ion conductive polymer refers to a polymer having conductivity of cations such as lithium. Specifically, the lithium-ion conductive polymer is a high molecular compound including a polar group to which cations can coordinate. The polar group is preferably an ether group, an ester group, a nitrile group, a carbonyl group, siloxane, or the like.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure. Alternatively, the lithium-ion conductive polymer may be a copolymer. The molecular weight is preferably greater than or equal to ten thousand, further preferably greater than or equal to hundred thousand, for example.

In the lithium-ion conductive polymer, lithium ions move by changing polar groups to interact with, due to the local motion (also referred to as segmental motion) of polymer chains. For example, in PEO, lithium ions move by changing oxygen to interact with, due to the segmental motion of ether chains. When the temperature is close to or higher than the melting point or softening point of the lithium-ion conductive polymer, the crystal regions are broken to increase amorphous regions, so that the motion of the ether chains becomes active and the ion conductivity increases. Thus, in the case where PEO is used as the lithium-ion conductive polymer, charging and discharging are preferably performed at higher than or equal to 60° C.

According to the ionic radius of Shannon (Shannon et al., Acta A 32 (1976) 751.), the radius of a monovalent lithium ion is 0.0590 nm in the case of tetracoordination, 0.076 nm in the case of hexacoordination, and 0.092 nm in the case of octacoordination. The radius of a bivalent oxygen ion is 0.135 nm in the case of bicoordination, 0.136 nm in the case of tricoordination, 0.138 nm in the case of tetracorrdination, 0.140 nm in the case of hexacoordination, and 0.142 nm in the case of octacoordination. The distance between polar groups included in adjacent lithium-ion conductive polymer chains is preferably greater than or equal to the distance that allows lithium ions and anion ions contained in the polar groups to exist stably while the above ionic radius is maintained. Furthermore, the distance between the polar groups is preferably close enough to cause interaction between the lithium ions and the polar groups. Note that the distance is not necessarily always kept constant because the segmental motion occurs as described above. The distance needs to be appropriate only when lithium ions are transferred.

As the lithium salt, it is possible to use a compound containing lithium and at least one of phosphorus, fluorine, nitrogen, sulfur, oxygen, chlorine, arsenic, boron, aluminum, bromine, and iodine. For example, one of lithium salts such as LiPF₆, lithium bis(fluorosulfonyl)imide (Li(FSO₂)₂N, abbreviation: LiFSI), LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination in an appropriate ratio.

It is particularly preferable to use LiFSI because favorable characteristics at low temperatures can be obtained. Note that LiFSI and LiTFSI are less likely to react with water than LiPF₆ or the like. This can relax the dew point control in fabricating an electrode and an electrolyte layer that use LiFSI. For example, the fabrication can be performed even in a normal air atmosphere, not only in an inert atmosphere of argon or the like in which moisture is excluded as much as possible or in a dry room in which a dew point is controlled. This is preferable because the productivity can be improved. When the segmental motion of ether chains is used for lithium conduction, it is particularly preferable to use a lithium salt that is highly dissociable and has a plasticizing effect, such as LiFSI or LiTFSI, in which case the operating temperature range can be widen.

Since the lithium-ion conductive polymer is a high molecular compound, the positive electrode active material 1011 and the conductive material can be bound onto the positive electrode current collector 1001 when the lithium-ion conductive polymer is sufficiently mixed in the positive electrode active material layer 1002. Thus, the positive electrode 1006 can be fabricated without a binder. Since the binder does not contribute to charge and discharge reactions, a smaller number of binders enable higher proportion of materials that contribute to charging and discharging, such as an active material and an electrolyte. As a result, the secondary battery 1000 can have higher discharge capacity, higher rate characteristics, improved cycle performance, and the like.

When the positive electrode active material layer 1002 and the electrolyte layer 1003 both contain the electrolyte 1010, contact between the positive electrode active material layer 1002 and the electrolyte layer 1003 can be favorable. As a result, the secondary battery 1000 can have higher discharge capacity, higher rate characteristics, improved cycle performance, and the like.

When containing no or extremely few organic solvent(s), the secondary battery can be less likely to catch fire and ignite and thus can have higher level of safety, which is preferable. When using the electrolyte 1010 containing no or extremely few organic solvent(s), the electrolyte layer 1003 can have enough strength and thus can electrically insulate the positive electrode and the negative electrode without a separator. Since a separator is not necessary, the secondary battery can have high productivity. When using the electrolyte 1010 containing an inorganic filler, the secondary battery can have higher strength and higher level of safety.

To obtain the electrolyte 1010 containing no or extremely few organic solvent(s), the electrolyte 1010 is preferably dried sufficiently. In this specification and the like, the electrolyte 1010 can be regarded as being dried sufficiently when a change in the weight after drying at 90° C. under reduced pressure for one hour is within 5%.

Furthermore, the electrolyte layer 1003 may contain an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile. The concentration of the material to be added in the whole electrolyte layer 1003 is, for example, higher than or equal to 0.1 wt % and lower than or equal to 5 wt %.

Note that materials contained in a secondary battery, such as a lithium-ion conductive polymer, a lithium salt, a binder, and an additive agent can be identified using nuclear magnetic resonance (NMR), for example. Analysis results of Raman spectroscopy, Fourier transform infrared spectroscopy (FT-IR), time-of-flight secondary ion mass spectrometry (TOF-SIMS), gas chromatography mass spectroscopy (GC/MS), pyrolysis gas chromatography mass spectroscopy (Py-GC/MS), liquid chromatography mass spectroscopy (LC/MS), or the like can also be used for the identification. Note that analysis by NMR or the like is preferably performed after the positive electrode active material layer 1002 is subjected to suspension using a solvent to separate the positive electrode active material 1011 from the other materials.

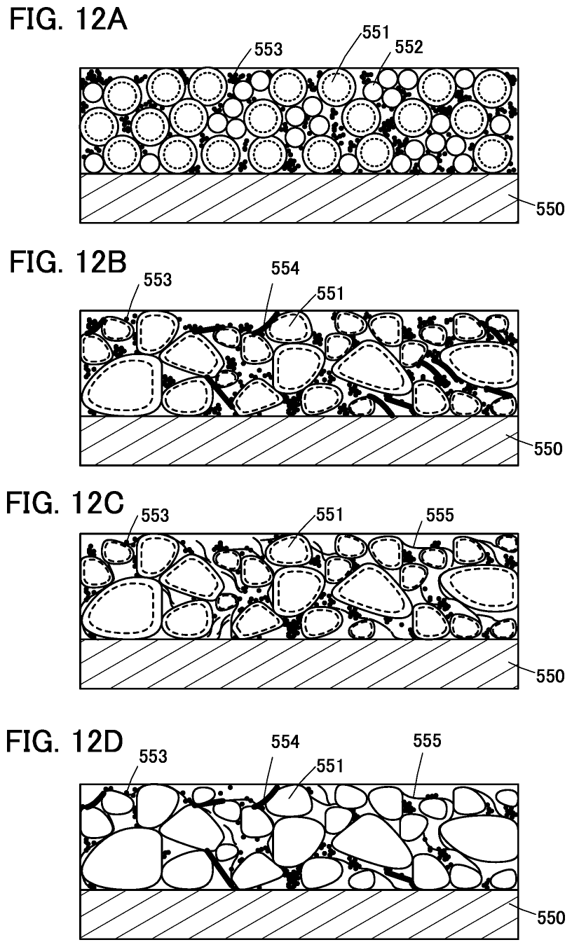

The positive electrode of this embodiment is not limited to have the cross-section illustrated in FIG. 11B. As an example different from that in FIG. 11B, FIGS. 12A to 12D each illustrate a cross section of a positive electrode.

In the positive electrode of the secondary battery, a binder (a resin) is mixed in order to fix a current collector 550 such as metal foil and an active material 551. The binder is also referred to as a binding agent. Since the binder is a high molecular material, a large number of binders lowers the proportion of the active material in the positive electrode, thereby reducing the discharge capacity of the secondary battery. Therefore, the number of binders is reduced to a minimum. In FIG. 12A, regions not filled with any of the active material 551 and a second active material 552 that are positive electrode active materials and an acetylene black 553 indicate spaces or binders.

In FIG. 12A, the acetylene black 553 is illustrated as a conductive material. FIG. 12A illustrates an example in which the second active materials 552 with a smaller particle diameter than the active materials 551 are mixed. The positive electrode including particles with different particle sizes can have high density. The active material 551 has a core-shell structure. Note that “core” is used not to indicate a core of the entire particle, but to show the positional relationship between the particle center and outer shell. In addition, “core” can also be referred to as a core material. For example, the active material 551 uses first NCM for its core and second NCM for its shell. A composite oxide represented by LiNixCoyMnzO₂ in which x:y:z=8:1:1 or x:y:z=9:0.5:0.5 can be used as the first NCM, and a composite oxide represented by LiNixCoyMnzO₂ in which x:y:z=1:1:1 can be used as the second NCM. Note that the atomic ratio of the second NCM is not limited to the above ratio. For example, when having a lower nickel proportion than the first NCM, the second NCM might have an effect similar to that of the second NCM having the above ratio.

In FIG. 12A, the boundary between the core region and the shell region of the active material 551 is indicated by a dotted line in the active material 551. Although FIG. 12A illustrates an example in which the active material 551 has a spherical shape, there is no particular limitation and other various shapes can be employed. The cross-sectional shape of the active material 551 may be an ellipse, a rectangle, a trapezoid, a triangle, a quadrilateral with rounded corners, or an asymmetrical shape.

FIG. 12B illustrates an example in which the active materials 551 have various shapes. The example illustrated in FIG. 12B is different from that in FIG. 12A.

In the positive electrode in FIG. 12B, graphene 554 is used as a carbon material used as the conductive material.

Graphene, which has electrically, mechanically, or chemically remarkable characteristics, is a carbon material that is expected to be applied to a variety of fields, such as field-effect transistors and solar batteries.

In FIG. 12B, a positive electrode active material layer containing the active material 551, the graphene 554, and the acetylene black 553 is formed over the current collector 550.

In the step of mixing the graphene 554 and the acetylene black 553 to obtain an electrode slurry, the weight of mixed carbon black is preferably 1.5 to 20 times, further preferably 2 to 9.5 times the weight of graphene.

When the graphene 554 and the acetylene black 553 are mixed in the above ratio range, the acetylene black 553 can be dispersed uniformly and less likely to be aggregated at the time of preparing the slurry. Furthermore, when the graphene 554 and the acetylene black 553 are mixed in the above ratio range, the positive electrode can have a higher density than that using only the acetylene black 553 as the conductive material. As the electrode density is higher, the capacity per unit weight can be higher. Specifically, the density of the positive electrode active material layer measured by gravimetry can be higher than 3.5 g/cc. In addition, it is preferable that the active material 551 be used for the positive electrode and the graphene 554 and the acetylene black 553 be mixed in the above ratio range, in which case synergy for higher capacity of the secondary battery can be expected.

The above features are advantageous for secondary batteries for vehicles.

When a vehicle becomes heavier with increasing number of secondary batteries, more energy is consumed to move the vehicle, which makes it difficult to increase the mileage. With the use of high-density secondary batteries, the mileage of the vehicle can be increased with almost no increase in the total weight.

Since more power is needed to charge the secondary battery with higher capacity in the vehicle, the charging rate is desirably high. What is called a regenerative charging, in which electric power temporarily generated when the vehicle is braked is used for charging, is performed under high rate charging conditions; thus, a secondary battery for a vehicle is desired to have favorable rate characteristics.

Using the active material 551 for the positive electrode and mixing acetylene black and graphene within an optimal range enable both higher electrode density and formation of an appropriate space needed for ion conduction, whereby a secondary battery for a vehicle which has high energy density and favorable output characteristics can be obtained.

In FIG. 12B, the boundary between the core region and the shell region of the active material 551 is indicated by a dotted line in the active material 551. In FIG. 12B, regions not filled with any of the active material 551, the graphene 554, and the acetylene black 553 indicate spaces or binders. A space is required for the solvent to penetrate the positive electrode; too many spaces lower the electrode density, too few spaces do not allow the solvent to penetrate the positive electrode, and a space that remains after the secondary battery is completed lowers the efficiency.

FIG. 12C illustrates an example of a positive electrode in which a carbon nanotube 555 is used instead of graphene. The example illustrated in FIG. 12C is different from that in FIG. 12B. With the use of the carbon nanotube 555, aggregation of carbon black such as the acetylene black 553 can be prevented and the dispersibility can be increased.

In FIG. 12C, regions not filled with any of the active material 551, the carbon nanotube 555, and the acetylene black 553 indicate spaces or binders.

FIG. 12D illustrates another example of a positive electrode. In the example illustrated in FIG. 12D, the active material 551 does not have the core shell structure. In addition, in the example illustrated in FIG. 12D, the carbon nanotube 555 is used in addition to the graphene 554. With the use of both the graphene 554 and the carbon nanotube 555, aggregation of carbon black such as the acetylene black 553 can be prevented and the dispersibility can be further increased.

In FIG. 12D, regions not filled with any of the active material 551, the carbon nanotube 555, the graphene 554, and the acetylene black 553 indicate spaces or binders.

A semi-solid-state secondary battery can be fabricated in the following manner: the electrolyte 1010 is provided over any one of the positive electrodes in FIGS. 12A to 12D, a negative electrode is provided over the electrolyte 1010, and the obtained stack is stored in a container (e.g., an exterior body or a metal can) or the like.

Although the structure example of a semi-solid-state secondary battery is described above, there is no particular limitation and a solvent can be used for the secondary battery. A secondary battery using a solvent can be fabricated in the following manner: a separator is provided over a positive electrode, a negative electrode is provided over the separator, the obtained stack is stored in a container (e.g., an exterior body or a metal can) or the like, and the container is filled with the solvent.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery fabricated using the active material 551 is a secondary battery having high charge and discharge capacity. The semi-solid-state battery can have high charge and discharge voltages. Alternatively, a highly safe or highly reliable semi-solid-state battery can be achieved.

This embodiment can be freely combined with any of the other embodiments.

### Embodiment 5

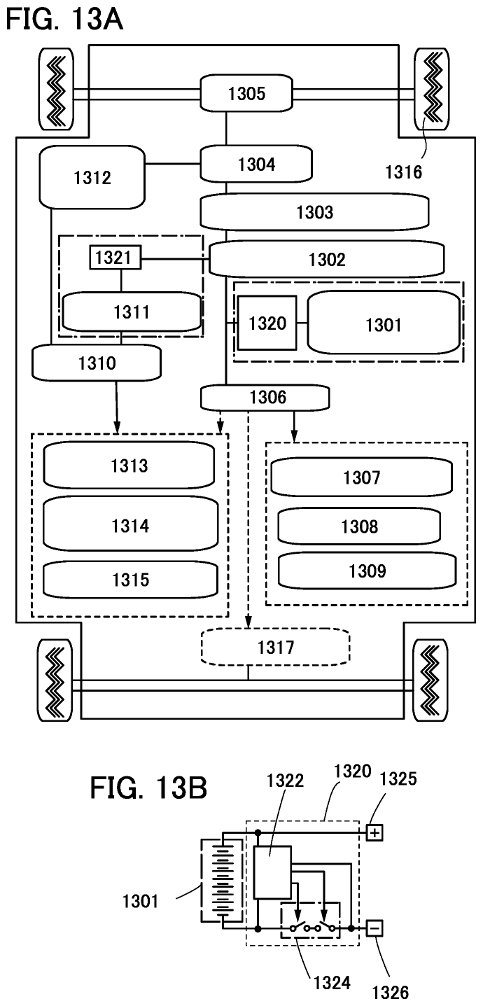

In this embodiment, examples of vehicles, electronic devices, and buildings each including a storage battery of one embodiment of the present invention are described with reference to FIGS. 13A and 13B, FIGS. 14A to 14D, FIGS. 15A to 15C, and FIGS. 16A and 16B.

Examples of electronic devices each including a storage battery include television devices (also referred to as televisions or television receivers), monitors of computers or the like, digital cameras, digital video cameras, digital photo frames, cellular phones (also referred to as mobile phones or mobile phone devices), portable game machines, portable information terminals, audio reproducing devices, and large game machines such as pachinko machines.

The storage battery can also be used in moving vehicles, typically automobiles. Examples of the automobiles include next-generation clean energy vehicles such as hybrid vehicles (HVs), electric vehicles (EVs), and plug-in hybrid vehicles (also referred to as PHEVs or PHVs), and the storage battery can be used as one of the power sources provided for the automobiles. The moving vehicle is not limited to an automobile. Examples of the moving vehicles include a train, a monorail train, a ship, and a flying object (a helicopter, an unmanned aircraft (a drone), an airplane, and a rocket), an electric bicycle, and an electric motorcycle, and these moving vehicles can use a storage battery of one embodiment of the present invention.

The storage battery of this embodiment may be used in a ground-based charging apparatus provided for a house or a charging station provided in a commerce facility.

First, FIG. 13A illustrates an example in which the storage battery described in part of Embodiment 1 is used in an electric vehicle (EV).

The electric vehicle is provided with a first storage battery 1301 as a main battery for driving and a second storage battery 1311 that supplies electric power to an inverter 1312 for starting a motor 1304. The second storage battery 1311 is also referred to as a cranking battery or a starter battery. The second storage battery 1311 specifically needs high output and does not necessarily have high capacity, and the capacity of the second storage battery 1311 is lower than that of the first storage battery 1301.

For the secondary batteries included in the first storage battery 1301, Embodiment 1 can be referred to.

Although this embodiment describes an example in which one first storage battery 1301 is provided, a plurality of first storage batteries 1301 may be connected in parallel. With a plurality of first storage batteries 1301, large electric power can be extracted. The plurality of first storage batteries 1301 may be connected in parallel, connected in series, or connected in series after being connected in parallel. The plurality of first storage batteries 1301 can also be referred to as an assembled battery.

The first storage battery 1301 provided for an automobile is provided with a service plug or a circuit breaker that can break an electrical connection with another storage battery or the like without the use of equipment.

Electric power from the first storage battery 1301 is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first storage battery 1301 is used to rotate the rear motor 1317.

The second storage battery 1311 supplies electric power to in-vehicle parts for 14 V (such as an audio 1313, power windows 1314, and lamps 1315) through a DC-DC circuit 1310.

The first storage battery 1301 is electrically connected to a control circuit portion 1320.

The control circuit portion 1320 may include a memory circuit including a transistor using an oxide semiconductor. A charge control circuit or a battery control system that includes a memory circuit including a transistor using an oxide semiconductor may be referred to as a battery operating system or a battery oxide semiconductor (BTOS).

A metal oxide functioning as an oxide semiconductor is preferably used. For example, as the metal oxide, a metal oxide such as an In-M-Zn oxide (the element M is one or more selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the metal oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the metal oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS has, for example, a composition in which elements included in a metal oxide are unevenly distributed. Materials including unevenly distributed elements each have a size greater than or equal to 0.5 nm and less than or equal to 10 nm, preferably greater than or equal to 1 nm and less than or equal to 3 nm, or a similar size. Note that in the following description of a metal oxide, a state in which one or more types of metal elements are unevenly distributed and regions including the metal element(s) are mixed is referred to as a mosaic pattern or a patch-like pattern. The regions each have a size greater than or equal to 0.5 nm and less than or equal to 10 nm, preferably greater than or equal to 1 nm and less than or equal to 3 nm, or a similar size.

In addition, the CAC-OS has a composition in which materials are separated into a first region and a second region to form a mosaic pattern, and the first regions are distributed in the film. This composition is hereinafter also referred to as a cloud-like composition. That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide has [In] higher than that in the composition of the CAC-OS film. Moreover, the second region of the CAC-OS in the In—Ga—Zn oxide has [Ga] higher than that in the composition of the CAC-OS film. Alternatively, for example, the first region has higher [In] and lower [Ga] than the second region. Moreover, the second region has higher [Ga] and lower [In] than the first region.

Specifically, the first region includes indium oxide, indium zinc oxide, or the like as its main component. The second region includes gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, according to EDX mapping obtained by EDX, the CAC-OS in the In—Ga—Zn oxide has a composition in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Iₒₙ), high field-effect mobility (μ), and favorable switching operation can be achieved.

An oxide semiconductor can have any of various structures that show various different properties. Two or more of an amorphous oxide semiconductor, a polycrystalline oxide semiconductor, an a-like OS, the CAC-OS, an nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is overheated. The off-state current of the transistor using an oxide semiconductor is lower than or equal to the lower measurement limit regardless of the temperature. On the other hand, the off-state current of the single crystal Si transistor largely depends on the temperature. For example, at 150° C., the off-state current of the single crystal Si transistor increases, and a sufficiently high current on/off ratio cannot be obtained. The control circuit portion 1320 can contribute to elimination of accidents due to secondary batteries, such as fires.

The control circuit portion 1320 that uses a memory circuit including a transistor using an oxide semiconductor can also function as an automatic control device for the secondary battery to resolve causes of instability, such as a micro-short circuit. Examples of functions of resolving the causes of instability include prevention of overcharging, prevention of overcurrent, control of overheating during charging, maintenance of cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit. The control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charging and discharging are impossible, but a phenomenon in which a slight short-circuit current flows through a minute short-circuit portion. Since a large voltage change is caused even when a micro-short circuit occurs in a relatively short time in a minute area, the abnormal voltage value might adversely affect anomaly prediction to be performed subsequently.

One of the supposed causes of a micro-short circuit is as follows. Uneven distribution of a positive electrode active material due to charging and discharging performed multiple times causes local current concentration at part of the positive electrode and part of the negative electrode; thus, insulation between the positive electrode and the negative electrode is partly broken. Another supposed cause is generation of a by-product due to a side reaction.

It can be said that the control circuit portion 1320 not only detects a micro-short circuit but also senses a terminal voltage of the secondary battery and controls the charge and discharge state of the secondary battery. For example, to prevent overcharging, the control circuit portion 1320 can turn off an output transistor of a charging circuit and an interruption switch substantially at the same time.

FIG. 13B is an example of a block diagram of the control circuit portion 1320.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first storage battery 1301. The control circuit portion 1320 is set to have the upper limit voltage and the lower limit voltage of the secondary battery used, and controls current from the outside and output current to the outside so that these currents do not exceed the upper limit. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first storage battery 1301 mainly supply electric power to in-vehicle parts for 42 V (for a high-voltage system), and the second storage battery 1311 supplies electric power to in-vehicle parts for 14 V (for a low-voltage system). Lead batteries are usually used for the second storage battery 1311 due to cost advantage.

In this embodiment, an example in which a lithium-ion secondary battery is used as both the first storage battery 1301 and the second storage battery 1311 is described. As the second storage battery 1311, a lead storage battery, an inorganic all-solid-state battery, and/or an electric double layer capacitor may alternatively be used.

Regenerative energy generated by rolling of tires 1316 is transmitted to the motor 1304 through a gear 1305, and is stored in the second storage battery 1311 through a motor controller 1303, a battery controller 1302, and a control circuit portion 1321. Alternatively, the regenerative energy is stored in the first storage battery 1301 through the battery controller 1302 and the control circuit portion 1320. For efficient charging with regenerative energy, the first storage battery 1301 is preferably capable of fast charging.

The battery controller 1302 can set the charge voltage, charge current, and the like of the first storage battery 1301. The battery controller 1302 can set charge conditions in accordance with charge characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first storage battery 1301 through the battery controller 1302. Some chargers are provided with a control circuit, in which case the function of the battery controller 1302 is not used; to prevent overcharging, the first storage battery 1301 are preferably charged through the control circuit portion 1320. In addition, a plug of the charger or a connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet with 50 kW, for example. Furthermore, charging can be performed with electric power supplied from external charging equipment by a contactless power feeding system or the like.

For fast charging, secondary batteries that can withstand high-voltage charging have been desired to perform charging in a short time.

The above storage battery described in this embodiment includes a secondary battery that operates at low temperatures and a secondary battery that operates in a middle temperature range. Thus, the storage battery can have stable output at low temperatures. Therefore, a vehicle using the storage battery can run safely even in cold climates.

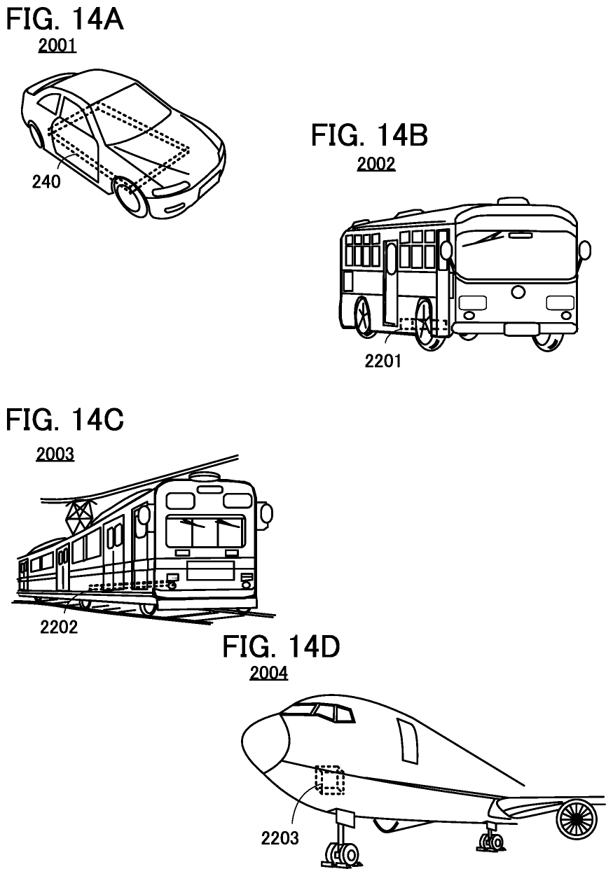

FIGS. 14A to 14D each illustrate an example of a transport vehicle that uses one embodiment of the present invention. An automobile 2001 illustrated in FIG. 14A is an electric vehicle that runs on the power of an electric motor. Alternatively, the automobile 2001 is a hybrid vehicle capable of running using either an electric motor or an engine as appropriate. In the case where a vehicle uses a secondary battery, the secondary battery for low-temperature use, the temperature sensor, and the heater that are described in Embodiment 1 are provided. In addition, using the semi-solid-state secondary battery described in Embodiment 5 can create synergy for higher safety. The automobile 2001 illustrated in FIG. 14A includes the storage battery 240 described in the above embodiment. In addition, a temperature control system for the storage battery 240, which is electrically connected to the storage battery 240, is preferably included.

The automobile 2001 can be charged when the secondary battery included in the automobile 2001 is supplied with electric power from external charging equipment by a plug-in system and/or a contactless power feeding system. In charging, a given method such as CHAdeMO (registered trademark) or Combined Charging System can be employed as a charging method, the standard of a connector, and the like as appropriate. A charging device may be a charging station provided in a commerce facility or a power source in a house. For example, with the use of a plug-in technique, the secondary battery for low temperatures included in the automobile 2001 can be charged by being supplied with electric power from outside. The charging can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle is stopped and/or driven. To supply electric power in such a contactless manner, an electromagnetic induction method or a magnetic resonance method can be used.

FIG. 14B illustrates a large transporter 2002 having a motor controlled by electricity as an example of a transport vehicle. A battery pack 2201 of the transporter 2002 includes the storage battery described in the above embodiment. Since the storage battery includes a secondary battery that operates at low temperatures and a secondary battery that operates in a middle temperature range, the transporter 2002 using the storage battery can run safely even in cold climates.

FIG. 14C illustrates a large transport vehicle 2003 having a motor controlled by electricity as an example. A battery pack 2202 of the transport vehicle 2003 includes more than 100 secondary batteries connected in series each having a voltage higher than or equal to 3.5 V and lower than or equal to 4.7 V, and has a maximum voltage of 600 V. Thus, the secondary batteries are required to have few variations in the characteristics. The battery pack 2202 includes the storage battery described in the above embodiment. Since the storage battery includes a secondary battery that operates at low temperatures and a secondary battery that operates in a middle temperature range, the transport vehicle 2003 using the storage battery can run safely even in cold climates.

FIG. 14D illustrates an aircraft 2004 having a combustion engine as an example. The aircraft 2004 illustrated in FIG. 14D including wheels for taking-off and landing can be regarded as a kind of transport vehicles. The aircraft 2004 includes a battery pack 2203 including the storage battery described in the above embodiment.

The storage battery of the aircraft 2004 has a maximum voltage of 32 V, for example. With the use of the storage battery of one embodiment of the present invention, the aircraft 2004 can be less likely to be affected by the ambient temperature.

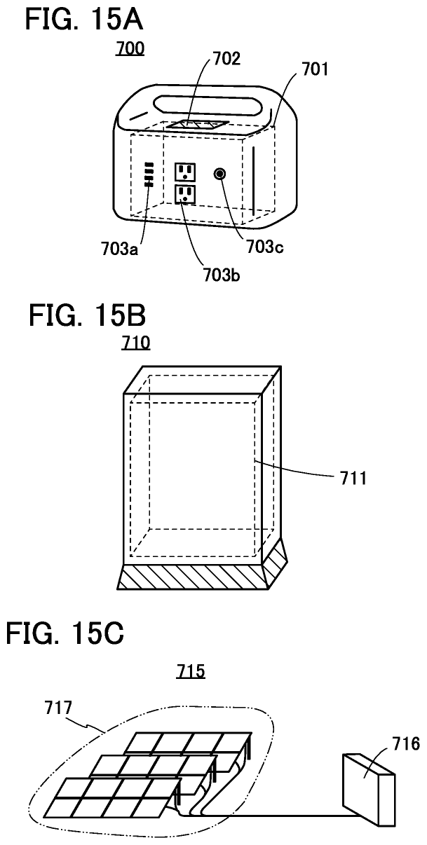

FIG. 15A illustrates an example in which the storage battery described in the above embodiment is used for a portable battery. A portable battery 700 includes a storage battery 701, a display portion 702, a terminal 703a, a terminal 703b, and a terminal 703c. With the use of the storage battery described in the above embodiment, the portable battery 700 can be used even in cold climates.

FIG. 15B illustrates an example in which the storage battery described in the above embodiment is used for a stationary power storage system. A stationary power storage system 710 includes a storage battery 711. The stationary power storage system 710 is preferably electrically connected to a commercial power source through a distribution board. With the use of the storage battery described in the above embodiment, the stationary power storage system 710 can be used even in cold climates.

FIG. 15C illustrates an example in which the storage battery described in the above embodiment is used for a solar power generation system. A solar power generation system 715 includes a storage battery 716 and solar power generation panels 717. Electric power obtained by the solar power generation panels can be stored in the storage battery 716. With the use of the storage battery described in the above embodiment, the solar power generation system 715 can be used even in cold climates.

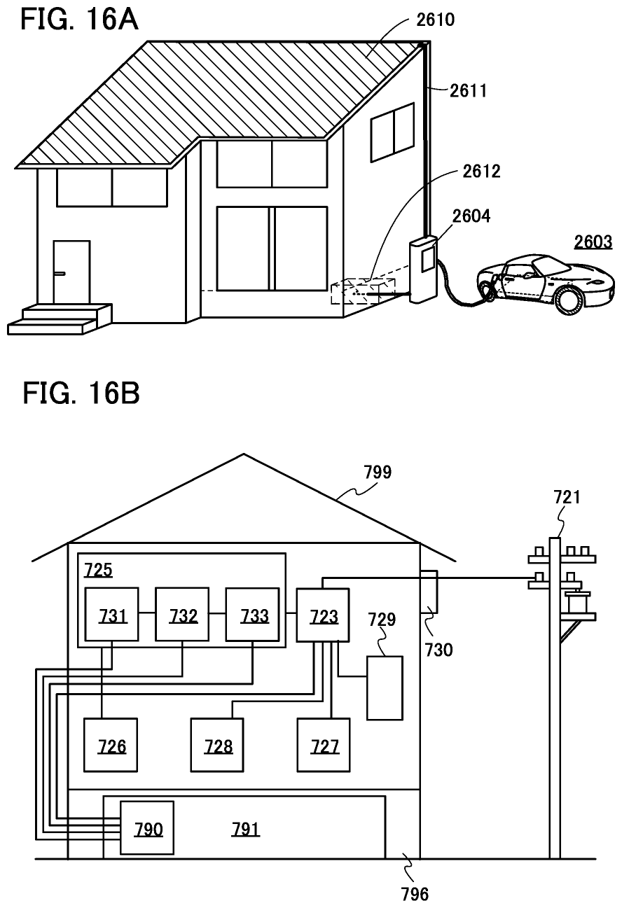

Next, examples in which the storage battery of one embodiment of the present invention is mounted on a building will be described with reference to FIGS. 16A and 16B.

A house illustrated in FIG. 16A includes a power storage device 2612 including the secondary battery of one embodiment of the present invention and a solar power generation panel 2610. The power storage device 2612 is electrically connected to the solar power generation panel 2610 through a wiring 2611 or the like. The power storage device 2612 may be electrically connected to a ground-based charging device 2604. Electric power generated by the solar power generation panel 2610 can be stored in the power storage device 2612. A secondary battery included in a vehicle 2603 can be charged with the electric power stored in the power storage device 2612 through the charging device 2604. The power storage device 2612 is preferably provided in an underfloor space, in which case the space on the floor can be effectively used. Alternatively, the power storage device 2612 may be provided on the floor.

The electric power stored in the power storage device 2612 can also be supplied to other electronic devices in the house. Thus, the electronic devices can be operated using the power storage device 2612 of one embodiment of the present invention as an uninterruptible power source even when electric power cannot be supplied from the commercial power source due to power failure or the like. With the use of the storage battery described in the above embodiment, the power storage device 2612 can supply electric power stably even in cold climates.

FIG. 16B illustrates an example of the power storage device of one embodiment of the present invention. As illustrated in FIG. 16B, a power storage device 791 of one embodiment of the present invention is provided in an underfloor space 796 of a building 799.

The power storage device 791 is provided with a control device 790, and the control device 790 is electrically connected to a distribution board 723, a power storage controller (also referred to as control device) 725, an indicator 726, and a router 729 through wirings.

Electric power is transmitted from a commercial power source 721 to the distribution board 723 through a service wire mounting portion 730. Moreover, electric power is transmitted to the distribution board 723 from the power storage device 791 and the commercial power source 721, and the distribution board 723 supplies the transmitted electric power to a general load 727 and a power storage load 728 through outlets (not illustrated).

The general load 727 is, for example, an electrical device such as a TV or a personal computer. The power storage load 728 is, for example, an electrical device such as a microwave, a refrigerator, or an air conditioner.

The power storage controller 725 includes a measuring portion 731, a predicting portion 732, and a planning portion 733. The measuring portion 731 has a function of measuring the amount of electric power consumed by the general load 727 and the power storage load 728 during a day (e.g., from midnight to midnight). The measuring portion 731 may also have a function of measuring the amount of electric power of the power storage device 791 and the amount of electric power supplied from the commercial power source 721. The predicting portion 732 has a function of predicting, on the basis of the amount of electric power consumed by the general load 727 and the power storage load 728 during a given day, the demand for electric power consumed by the general load 727 and the power storage load 728 during the next day. The planning portion 733 has a function of making a charge and discharge plan of the power storage device 791 on the basis of the demand for electric power predicted by the predicting portion 732.

The indicator 726 can show the amount of electric power consumed by the general load 727 and the power storage load 728 that is measured by the measuring portion 731. An electrical device such as a TV or a personal computer can also show it through the router 729. Furthermore, a portable electronic terminal such as a smartphone or a tablet can also show it through the router 729. The indicator 726, the electrical device, and the portable electronic terminal can also show, for example, the demand for electric power depending on a time period (or per hour) that is predicted by the predicting portion 732.

This embodiment can be implemented in combination with any of the other embodiments.

### Example

In this example, secondary batteries each containing an ionic liquid in an electrolyte solution were fabricated, and the discharge characteristics at a low temperature were evaluated.

An electrolyte solution 1 was fabricated in such a manner that an ionic liquid containing 1-ethyl-3-methylimidazolium (EMI) as a cation and bis(fluorosulfonyl)imide (FSI) as an anion (hereinafter, the ionic liquid is referred to as EMI-FSI) was mixed with 2.15 mol/L of lithium bis(fluorosulfonyl)imide (LiFSI).

An electrolyte solution 2 was fabricated in such a manner that EMI-FSI and ethylene carbonate (EC) that is a cyclic carbonate were mixed in a volume ratio of 7:3, and the mixture was mixed with 2.15 mol/L of LiFSI.

An electrolyte solution 3 was fabricated in such a manner that EMI-FSI and fluoroethylene carbonate (FEC) that is a cyclic carbonate were mixed in a volume ratio of 7:3, and the mixture was mixed with 2.15 mol/L of LiFSI.

An electrolyte solution 4 was fabricated in such a manner that EMI-FSI and diethyl carbonate (DEC) that is a chain-like carbonate were mixed in a volume ratio of 7:3, and the mixture was mixed with 2.15 mol/L of LiF SI.

An electrolyte solution 5 was fabricated in such a manner that EMI-FSI and ethylmethyl carbonate (EMC) that is a chain-like carbonate were mixed in a volume ratio of 7:3, and the mixture was mixed with 2.15 mol/L of LiFSI.

As a positive electrode active material contained in a positive electrode, lithium nickel-cobalt-manganese oxide (produced by MTI) was used. Acetylene black (AB) was prepared as a conductive material, and polyvinylidene fluoride (PVDF) was prepared as a binder. Then, the positive electrode active material, AB, and PVDF were mixed in a weight ratio of 95:3:2 to prepare slurry, and the slurry was applied on an aluminum current collector. As a solvent of the slurry, N-methyl-2-pyrrolidone (NMP) was used. After the current collector was coated with the slurry, the solvent was volatilized. Through the above steps, the positive electrode was obtained.

As a separator, a layered sheet of polypropylene and glass fiber filter paper (produced by Whatman Ltd.) was used with the polypropylene positioned on the positive electrode side.

A lithium metal was prepared for a counter electrode.

Coin-type half cells were fabricated using the electrolyte solutions 1 to 5, the positive electrode, the separator, and a negative electrode.

Table 1 shows the fabrication conditions of the electrolyte solutions 1 to 5 and their viscosities at −15° C.

TABLE 1

| Name of Sample | | Viscosity |
|---|---|---|
| Mixing condition | Composition | (−15° C.) |
| Electrolyte solution 1 | 2.15 M-LiFSI | 534 mPa · s |
| Only ionic liquid | EMI-FSI | |
| Electrolyte solution 2 | 2.15 M-LiFSI | 512 mPa · s |
| Ionic liquid + cyclic carbonate | EMI-FSI: EC = 7:3 | |
| Electrolyte solution 3 | 2.15 M-LiFSI | 368 mPa · s |
| Ionic liquid + cyclic carbonate | EMI-FSI: FEC = 7:3 | |
| Electrolyte solution 4 | 2.15 M-LiFSI | 363 mPa · s |
| Ionic liquid + chain-like carbonate | EMI-FST: DEC = 7:3 | |
| Electrolyte solution 5 | 2.15 M-LiFSI | 306 mPa · s |
| Ionic liquid + chain-like carbonate | EMI-FSI: EMC = 7:3 | |

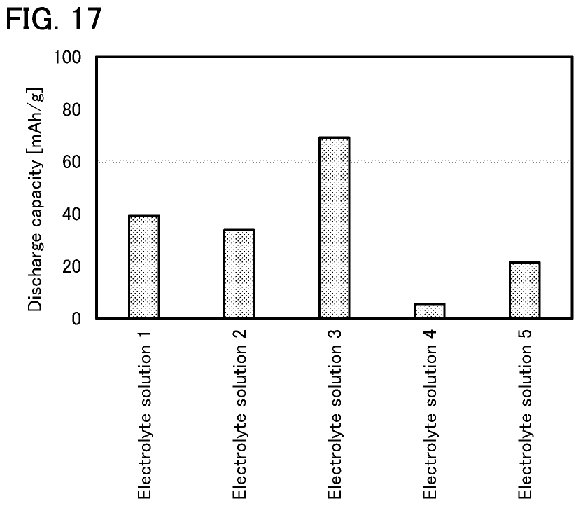

The secondary batteries fabricated using the electrolyte solutions 1 to 5 were subjected to a charge and discharge test at −20° C. FIG. 17 shows the discharge capacity after charging at 0.02 C for 50 hours and discharging at 0.2 C for five hours.

As shown in FIG. 17, the secondary battery using the electrolyte solution 1 using only an ionic liquid and the secondary batteries using the electrolyte solutions 2 and 3 using an ionic liquid and a cyclic carbonate had relatively favorable discharge capacity. On the other hand, the secondary batteries using the electrolyte solutions 4 and 5 using an ionic liquid and a chain-like carbonate had lower discharge capacity despite relatively low viscosities of the electrolyte solutions.

The above results revealed that the secondary batteries using only an ionic liquid or both an ionic liquid and a cyclic carbonate as their electrolyte solutions had relatively high discharge capacity even in a low temperature environment of −20° C. It was also found that the use of a cyclic carbonate containing fluorine particularly contributed to higher discharge capacity.

This application is based on Japanese Patent Application Serial No. 2020-197235 filed with Japan Patent Office on Nov. 27, 2020, the entire contents of which are hereby incorporated by reference.

What is claimed is:

1. A storage battery comprising:
a first lithium-ion secondary battery; and
a second lithium-ion secondary battery,
wherein the first lithium-ion secondary battery and the second lithium-ion secondary battery are adjacent to each other,
wherein the first lithium-ion secondary battery comprises at least one of an ionic liquid, a molecular crystalline electrolyte, a semi-solid-state electrolyte, an all-solid-state electrolyte, and lithium titanate, and
wherein the second lithium-ion secondary battery comprises an organic electrolyte solution.

2. The storage battery according to claim 1, further comprising:
a temperature sensor; and
a control circuit,
wherein an operating temperature range of the first lithium-ion secondary battery is a first temperature range,
wherein an operating temperature range of the second lithium-ion secondary battery is a second temperature range comprising an upper limit of the first temperature range,
wherein a lower limit of the first temperature range is lower than a lower limit of the second temperature range,
wherein the temperature sensor is configured to sense a temperature of the second lithium-ion secondary battery, and
wherein the control circuit is configured to make the first lithium-ion secondary battery generate heat so that the second lithium-ion secondary battery is heated to the second temperature range, when the temperature sensed by the temperature sensor is lower than the second temperature range.

3. The storage battery according to claim 1,
wherein the first lithium-ion secondary battery serves as an auxiliary heat source, and
wherein the second lithium-ion secondary battery is configured to start to perform discharging to the outside after the temperature reaches the second temperature range.

4. The storage battery according to claim 1,
wherein the number of the first lithium-ion secondary batteries is smaller than the number of the second lithium-ion secondary batteries.

5. The storage battery according to claim 1,
wherein the first lithium-ion secondary battery and the second lithium-ion secondary battery are rectangular solids and placed such that their largest surfaces face each other.

6. The storage battery according to claim 5,
wherein a material having higher thermal conductivity than air is contained between the first lithium-ion secondary battery and the second lithium-ion secondary battery.

7. The storage battery according to claim 1,
wherein the first lithium-ion secondary battery and the second lithium-ion secondary battery each have a cylindrical shape, and
wherein a material having higher thermal conductivity than air is contained between the first lithium-ion secondary battery and the second lithium-ion secondary battery.

8. The storage battery according to claim 2, comprising:
a plurality of the first lithium-ion secondary batteries; and
an inverter,
wherein the control circuit is configured to make the inverter to convert discharge current of one of the first lithium-ion secondary batteries into AC current, and to allow repeated charging and discharging on another one of the first lithium-ion secondary batteries using the AC current, when the temperature sensed by the temperature sensor is lower than the second temperature range.

9. The storage battery according to claim 2,
wherein the control circuit is configured to detect at least one of overcharging, overdischarging, and overcurrent to protect the first lithium-ion secondary battery and the second lithium-ion secondary battery.

10. The storage battery according to claim 1,
wherein the first lithium-ion secondary battery comprises an ionic liquid and an organic electrolyte solution.

11. A vehicle comprising the storage battery according to claim 1.

12. A storage battery comprising:
a first lithium-ion secondary battery; and
a second lithium-ion secondary battery,
a temperature sensor; and
a control circuit,
wherein the first lithium-ion secondary battery and the second lithium-ion secondary battery are adjacent to each other,
wherein the second lithium-ion secondary battery comprises an organic electrolyte solution.
wherein an operating temperature range of the first lithium-ion secondary battery is a first temperature range,
wherein an operating temperature range of the second lithium-ion secondary battery is a second temperature range comprising an upper limit of the first temperature range,
wherein a lower limit of the first temperature range is lower than a lower limit of the second temperature range, and
wherein the temperature sensor is configured to sense a temperature of the second lithium-ion secondary battery.

13. The storage battery according to claim 12,
wherein the control circuit is configured to make the first lithium-ion secondary battery generate heat so that the second lithium-ion secondary battery is heated to the second temperature range, when the temperature sensed by the temperature sensor is lower than the second temperature range.

14. The storage battery according to claim 12,
wherein the first lithium-ion secondary battery serves as an auxiliary heat source, and
wherein the second lithium-ion secondary battery is configured to start to perform discharging to the outside after the temperature reaches the second temperature range.

15. The storage battery according to claim 12,
wherein the number of the first lithium-ion secondary batteries is smaller than the number of the second lithium-ion secondary batteries.

16. The storage battery according to claim 12,
wherein the first lithium-ion secondary battery and the second lithium-ion secondary battery are rectangular solids and placed such that their largest surfaces face each other.

17. The storage battery according to claim 12,
wherein a material having higher thermal conductivity than air is contained between the first lithium-ion secondary battery and the second lithium-ion secondary battery.

18. The storage battery according to claim 12,
wherein the first lithium-ion secondary battery and the second lithium-ion secondary battery each have a cylindrical shape, and
wherein a material having higher thermal conductivity than air is contained between the first lithium-ion secondary battery and the second lithium-ion secondary battery.

19. The storage battery according to claim 12, comprising:
a plurality of the first lithium-ion secondary batteries; and
an inverter,
wherein the control circuit is configured to make the inverter to convert discharge current of one of the first lithium-ion secondary batteries into AC current, and to allow repeated charging and discharging on another one of the first lithium-ion secondary batteries using the AC current, when the temperature sensed by the temperature sensor is lower than the second temperature range.

20. The storage battery according to claim 12,
wherein the control circuit is configured to detect at least one of overcharging, overdischarging, and overcurrent to protect the first lithium-ion secondary battery and the second lithium-ion secondary battery.

21. The storage battery according to claim 12,
wherein the first lithium-ion secondary battery comprises an ionic liquid and an organic electrolyte solution.

22. A vehicle comprising the storage battery according to claim 12.
